(19) United States
(12) Patent Application Publication
(10) Pub. No.: US 2007/0079012 A1
(43) Pub. Date: Apr. 5, 2007

(54) Universal electronic payment system: to include "PS1 & PFN Connect TM", and the same technology to provide wireless interoperability for first responder communications in a national security program

(76) Inventor: Richard Clark Walker, Waldorf, MD (US)

Correspondence Address: Richard Walker, 15000 Hunters Harbor Lane, Waldorf, MD, 20601, US

(21) Appl. No.: 11/353,063

(22) Filed: Feb. 14, 2006

Related U.S. Application Data
(60) Provisional application No. 60/651,974, filed on Feb. 14, 2005.
(60) Provisional application No. 60/651,975, filed on Feb. 14, 2005.

(51) Int. Cl. G06F 15/16

(52) U.S. Cl. 709/249

(57) ABSTRACT

The invention comprises two wireless repeater/controller devices which interface all types of electronic messaging and provide local inter protocol translation and routing to both distant networks and locally, to mini smart cells made up of these two units. The units are termed Primary Focal Node PFN and PS-1 (a smaller dedicated self powered version). The PS-1 micro processes specific signal from sensors, scanners readers, video- cams, audio pickups, and other connected wireless, etc. and delivers the signal conditioned, secure and encrypted to the larger version or PFN for any further processing and translation for longer range wireless communications. This technology is called the Primary Focal Node/Trusted Remote Activity Control or PFN/TRAC System, and is a movement management system designed to enhance public safety and national security through a software program call Federal Access Control Technology, The applications taught and claimed for this singular architecture in this specification are universal electronic payment, and universal translation for First Responder Radios.

### RELATED APPLICATIONS

This application claims priority from U.S. Provisional Patent Application No. 60/651,974 filed Feb. 14, 2005 and US Provisional Patent Application No. 60/651,975 filed Feb. 14, 2005, to from U.S. patent application Ser. No. 11,259,201 filed on Oct. 27, 2005 to from U.S. Provisional Patent Application No. 60/514,833 filed on Oct. 28, 2003; Ser. No. 60/421.572, filed Sep. 22, 2003; Oct. 28, 2002, filed incorporated herein.

This application also claims priority from U.S. Provisional Patent Application No. 60/363,950, filed Mar. 14, 2002, incorporated herein.

This application also claims priority from and/or is related to U.S. Provisional Application Nos. 60/325,538, filed Oct. 1, 2001; Ser. No. 60/330,088, filed Oct. 19, 2000; Ser. No. 60/200,872, filed May 1, 2000; Ser. No. 60/176,818, filed Jan. 19, 2000; Ser. No. 60/139,759, filed Jun. 15, 1999; Ser. No. 60/140,029, filed Jun. 18, 1998, Ser. No. 60/032,217 filed on Dec. 2, 1996, all of which are hereby incorporated by reference.

This application also claims priority from and/or is related to U.S. patent application Ser. No. 08/975,140, filed Nov. 20, 1997; Ser. No. 09/357,373, filed Jul. 20, 1999; Ser. No 09/738,901, filed Dec. 18, 2000; Ser. No. 09/914,299, filed Jan. 14, 2002; Ser. No. 10/018,095, filed Dec. 14, 2001; Ser. No. 10/260,525, filed Oct. 1, 2002 and International Patent Application No. PCT/US97/21516, filed on Nov. 24, 1997; all of which are hereby incorporated by reference.

### BACKGROUND OF THE INVENTION

### Field of the Invention

More and more the electronic payment industry is invading the world of change and paper currency. However, the problem is that there are so many different payment instruments that do not serve the public well because of so much variance in the technologies. Therefore the invention has been created. It is a universal electronic interface platform that supports all of the existing devices and has room for new ID Systems like Biometrics. The invention an innovation on the PFN/TRAC/FACT System of accountable remote control and wireless relay and routing management additionally has FACT security architecture and programming that co resides with other commercial and security data delivery and data mining software in local processors and remote processors/servers and mass data processing centers, which harvest specific data to track dangerous individuals and dangerous materials on a real-time basis with the availability to identify any dangerous combination of the two, in real-time both locally and at a distance (regionally, nationally globally or as desired)

The invention locally is comprised to two hardware components or wireless interface platforms, termed a Primary Focal Node PFN and the PS1 a smaller version and generally (a self contained power (P) system(S) e.g. battery version, some times referred to as 1PS when carried by a person or implemented with a living application, rather than applied to piece of equipment or object). However, in the electronic payment industry in most cases, the primary power comes from a host machine an is preceded by 1 E for equipment PFN or 1SV PFN for 12V mobile vehicles. These discriminating identifiers are necessary for the machine controller and input voltage that these different applications require. But the communication routing or repeating process is to be possible through all Primary Focal Nodes PFNs 1PS, PS1 and HS 1 wireless sensors or signal generators (repeaters/translators).

Obviously the electronic payment industry involves commercial tracking and telemetry of product, materials, and resources as well as, the secure delivery of payment for these things and the delivery of tax- just like the need for secure communications and data transfer in public safety and national security work. Both require the secure and efficient processing of sensitive information and data that is restricted to a need to know basis, and the many and individual communication assets change in geographic location, purpose and combination in real-time.

These similar requirements are satisfied by similar technical architectures but they use frequencies and programming. However, the basic circuit design and architecture is the same between the PS1 and PFN platforms that has been detailed for numerous prior or related applications involving the establishment of transient smart cells that are, instant data routers and accountable

### SUMMARY OF INVENTION

The Summary to be Written in the Final Formal Filing

### BRIEF DESCRIPTION OF DRAWINGS

FIG. 1 Universal electronic payment Architecture”

FIG. 2 Vending machine processor

FIG. 3 Local wireless Node and Relay Station

FIG. 4 Trusted remote Activity Control Architecture

FIG. 5 Exemplary vending machine for restroom paper product

FIG. 6 Kline Walker LLC Universal Electronic Payment Block PS1 to PFN

FIG. 7 1Pi imbedded chip

FIG. 8 PFN router for First Responders

FIG. 9 Flow chart for translation interface

### DESCRIPTION OF THE DRAWINGS

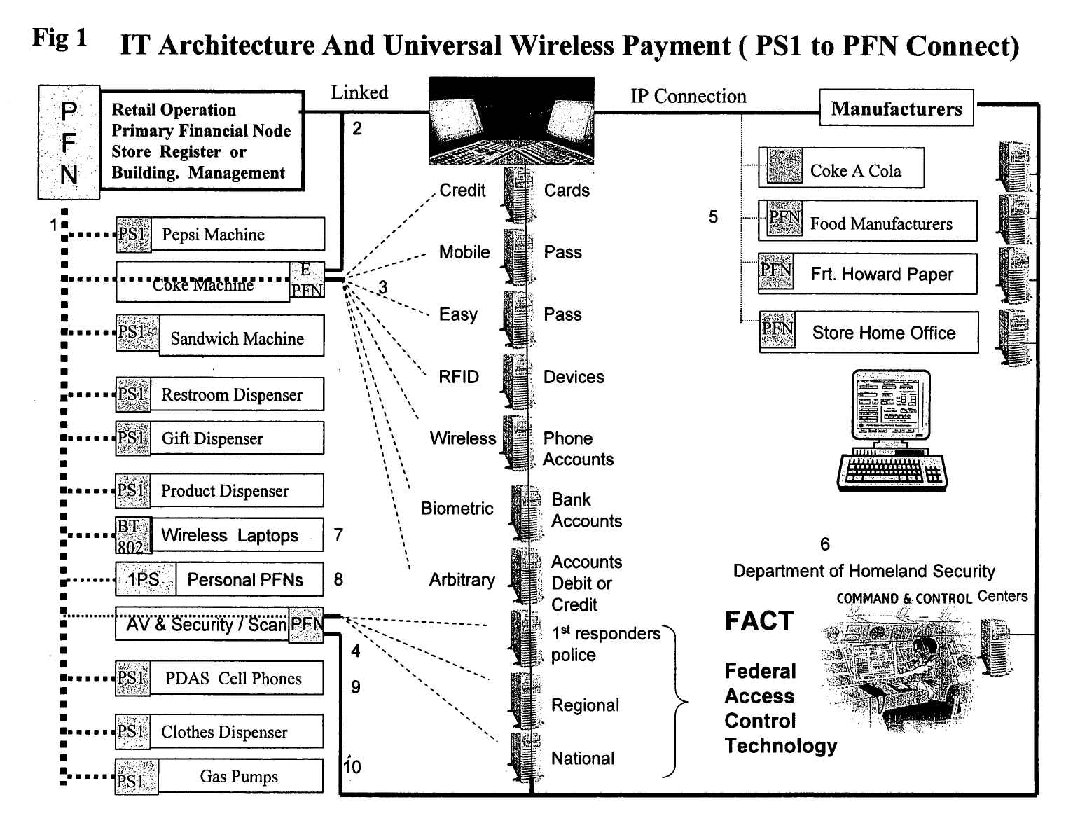

FIG. 1

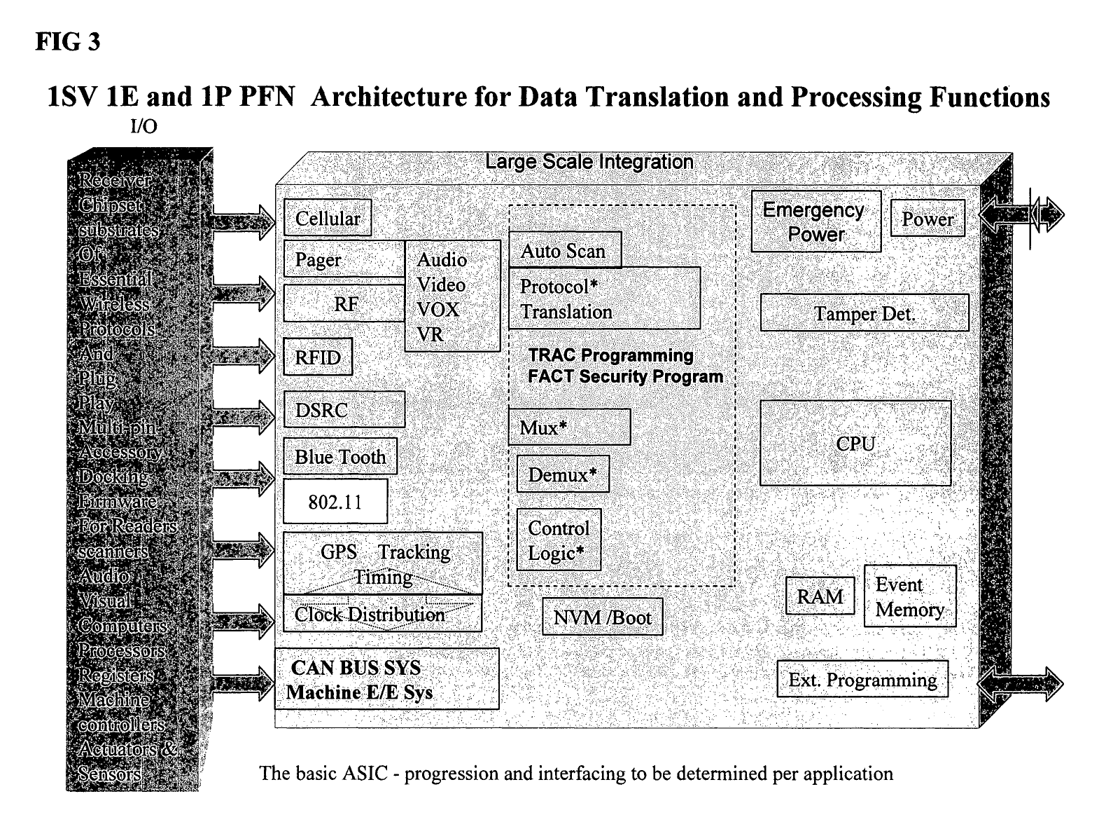

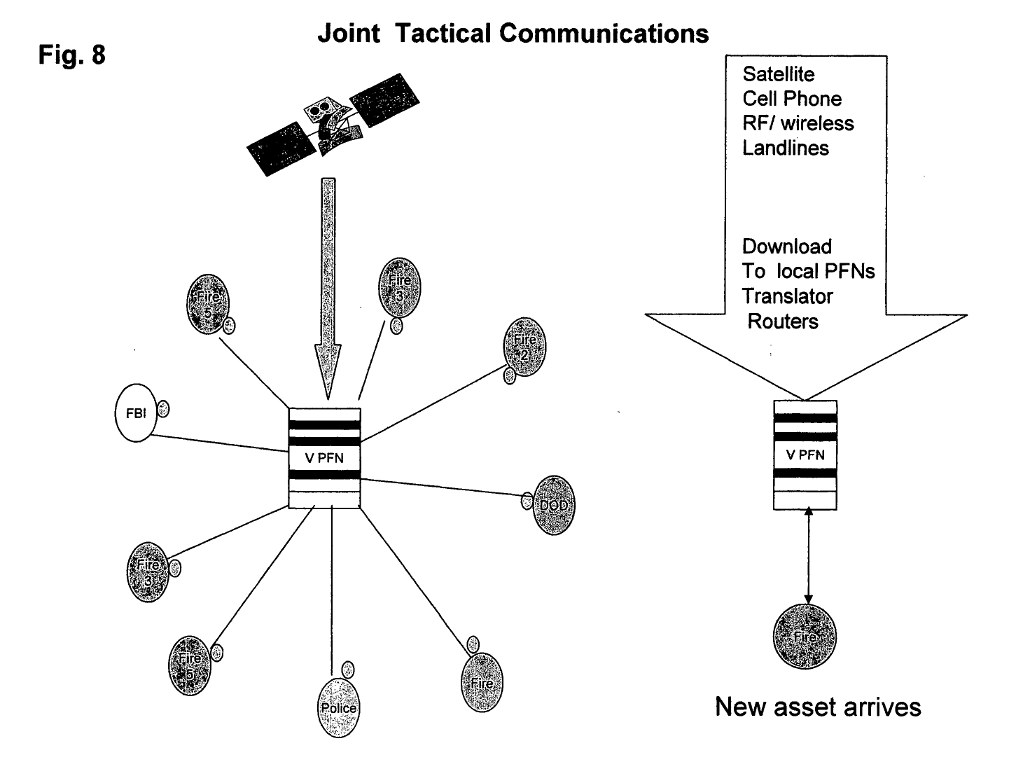

FIG. 1 through FIG. 5 teaches the PFN router/relay/equipment controller along with today's more limited PS1 and 1PS platform is the commercial application of electronic payment. Starting in the upper left hand corner with the No. 1 below the “PFN Retail Operation/Primary Financial Node/Store Register or a Building Management computer the reader can see numerous dotted lines through out the figure. These dotted lines represent wireless communications (some are dedicated short range and others are long range wireless. The Primary Financial Node (PFN) actually comes from the PFN/TRAC System technology Where (PFN) stands for Primary Focal Node and (TRAC) means Trusted Remote Activity controller. The Primary focal node is a machine controller and a multiple communication relay station that interfaces many forms of wireless and fixed wire data links. The general Application Specific Circuit Design (ASIC) for the various PFNS is further detailed in FIG. 3. Additionally the same circuit appears in FIG. 8 showing it employed in emergency response coordination and Homeland security applications requiring data and communication routing, relay and translation The specific Primary Focal Nodes are termed by their application i.e. 1A PFN Aircraft Controller, 1E PFN Equipment Controller, 1SV Surface Vehicle PFN, I RR Rail Road PFN, 1 M Marine PFN, 1P Personal, 1Pi Personal PFN imbedded and 1 Mil Military PFN. The two platforms the PFN and the 1PS, PS1 and HS1 will move more closely together in hardware architecture as the future employs more SOC technology and places more systems on an individual chip. This process has already aided the cellular phone industry to blatenly produce and sell wireless phones that are actually personal 1P PFNs with digital cameras, stream video, PDA processors, to include the wireless PDA products, interfaced with wireless phone technology and capacity to run windows and web browsers and function on the internet. All of which was taught as a Personal PFN and or 1PS unit. A phone is a audible communication device, and the Primary Focal Node or Personal Primary Focal Node is a personal interaction terminal for a people to handle many data streams. And, other PFNs are vehicle and equipment Primary Focal Nodes to handle secure communications, remote control signals and process/route translate and or relay signal and data with accountability (for commercial use and security). The theft of Primary Focal Node technology is being used to redefine what a phone has always been since its inception and real crime against the small inventors of America

To return to other PFN applications involving machine interface and controller function like Flight and Rail travel, some automated/remote control development have taken a progressive approach design like the TRACker. The TRACker is a PFN that can interface and operate at various levels of redundant system capacity, and or integration as desired, but is kept parallel without being directly connected to established hardware systems. The 1SV PFN is a land based surface mobile equipment PFN however, the automotive progressive PFN has the prefix abbreviation DRC for Driver Resource Center PFN and provides for the remote purchase of vehicle accessories and services from remote manufacturers in real-time. In this application and other applications the electronic payment industry has been incorporated with the vehicle PFNs and supported credit card swipe interface since 1997 (prior applications).

The DRC PFN also does more than this because it is an interface for all forms of wireless communication and incorporates COTS products like OnStar and other vehicle tracking and telemetry commercial service, product and operations, and links their functions locally and remotely to Home Land Security and local law enforcement for public safety and national security in real-time, with protection for personal privacy.

Once again, many of these telematics companies and functions are direct infringements on the protected technology of the PFN/TRAC/FACT System (Prior Related Technology) and will respond positively and appreciate the completeness the entire system (invention) brings to their business. Hopefully, they will be cooperative in making the appropriate commercial arrangements to satisfy the nations need for a integrated telematics network, inter-operative first responder communication system and this small inventor and investment team that has been doing much of the heavy innovative lifting. The advantages to homeland security and local public safety are significant, but no less important than protecting US Constitutional rights that guarantees recognition and payment for our citizens creative efforts, over and above a poor economic tool that presently allows for theft and false profit (A practice called Smart Business by some).

To return to this Citizens genuine effort to technically secure America Normal commercial business can be monitored to defined dangers with vigilant automated machine surveillance that is protected and secure and allows for both automated and remote control response coupled with a better protected human response, that is more accurate, less disruptive, destructive, safer and more secure for all. The PFN unit is optionally a physically protected unit which is well detailed in the related prior patents and protected applications. It has a long term power source as a backup and reenergizes the protected power source from the host machine it is interfaced and re-energized through the electronic/electrical E/E System of the machine i.e machines: vending, vehicle, boat, plane, train, etc. Contemplation of future power supplies for the PFN include the use room temperature super conductors and Zero point energy harvested from the surrounding environment/atmosphere, and any number of new technologies that either generate, capture or store electrical energy more efficiently, with any and all of such advances falling within the nature and scope of the inventions power supply requirement. A requirement with the constant focus to maintain stable power for reliable processing and communications for an efficient secure network or web, which include other PFNs/PS1s for commercial data and financial transactions, and to create a national data mining security matrix No. 6 (FACT, aka Federal Access Control Technology for Homeland Security). The FACT Security System is well documented through all the applications of industry, commerce and government in prior related art incorporated herein by reference.

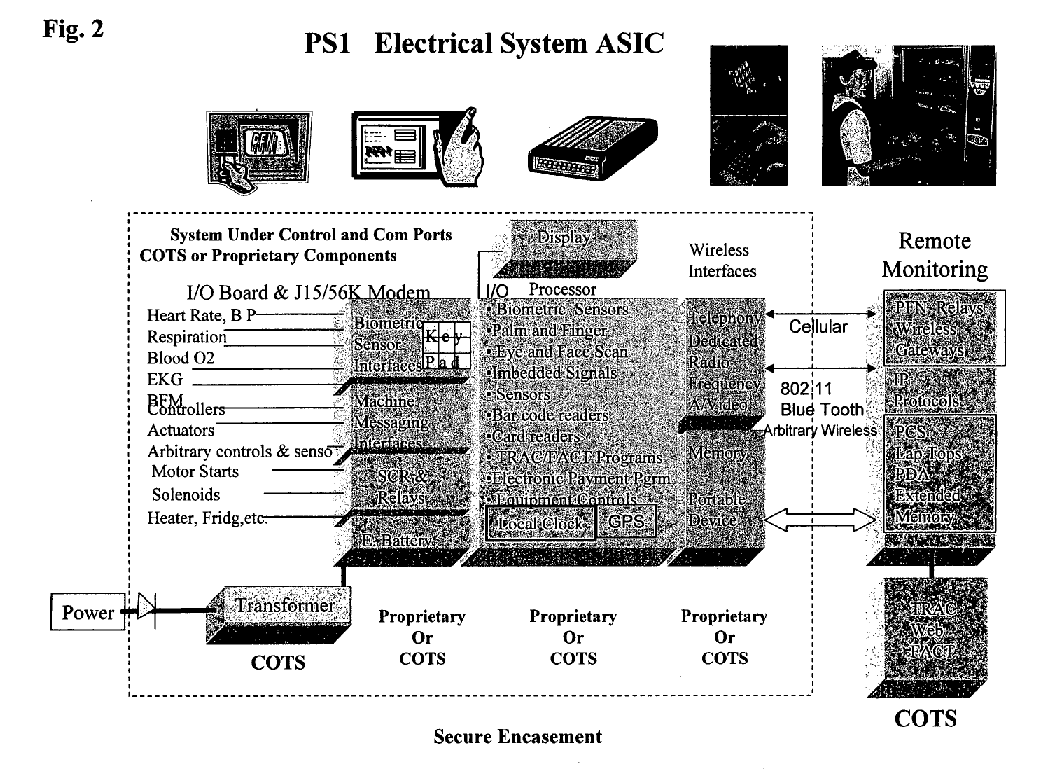

The smaller mini wireless PFN called the PS1 is shown to the left of the figure. The PS1 circuit is detailed in more depth in FIG. 2 however, the PS1 normally stands for stand alone power or Power System required PS. Today that means a power storage component like a battery which requires maintenance, obviously in the future as discussed above this modality can be eliminated with other technology requiring little or no up keep for an electrical source. All the self powered PS1 applications in the other related patent applications use re-generable power when available and practical i.e. solar, wind, water, motion, etc. However, in this application batteries are used only when absolutely necessary like a restroom dispenser not close enough to a traditional power source, plug etc.

With this in mind the power from the equipment or building current is transformed and rectified in the standard fashion and used to energize the PS1 backup battery and drive typical computer processor operations TTL logic voltages as a general rule. PS1 and or mini PFNs in this application are designed as universal payment terminals to read a credit card, receive a electronic payment device, even sense body parts or communicate credit information and identity data via both cellular communications and broad band short range (blue tooth and or 802.11) or narrow band CDMA,TDMA via appropriate SOC receiver chipsets and protocol firmware. Without revealing specifics of NEC and other electronic industry software and code the PS1 processes 128/the new 256 encrypted data encrypted protocols to local PFNs via a broad band dedicated short range communication DSRC, which intern connects via land lines or long range wireless telephony (Cellular) to wireless gateways and credit and manufacturer commercial servers, this call can take place via the machine PFN or from the users cell phone through either short range device to device transmissions or through the commercial wireless phone system.

Federal Access Control Technology or FACT programming co- resides with the other programs in a TRAC processor (or trusted processor an system). The FACT programming can be disseminated via the FACT security matrix for local FACT programming to be stored in both the PFN and the PS1 or any capable processor and system desired to complete or extend the technology. Such programming and command instructions might include the tracking of a particular product or Lot registered by a connected machine (PFN/processor) and barcode reader and or via RFID technology or a small imbedded chip in the product or miro transceiver denoting a specific purchase of materials that in the wrong hand pose a security threat to the nation. Especially important, the PFN is designed to watch the watching, meaning such individual surveillance will also have real-time judicial review to make sure any secret tracking and telemetry that violate an individuals rights to privacy meets the requirement to do such activities and is maintained within the parameters requested with all other data eliminated immediately, and or the real-time revocation of such out a bounds surveillance (this is defined in earlier related filings).

Retuning to FIG. 1 the entire left column is made up of automated machinery responsive to the PFNs in the store and or office building. At the top of the page the big vertical lettered PFN is connected to the register or a store computer, or as stated at the top part of the electronic building management system. The variations at this level are endless. The PFN can be the sole management system, part of an existing security controller, or system, or electronic fire sensing and extinguishing system controller, or tied to any existing computer or IT architecture, or used to tie all these systems together. In any event, it has a stable source of power with backup, the building keeps the power stable and recharges the backup battery to insure completed operation to all input it is intended or capable to interface with.

No. 2 in the drawing shows the hard wire connections to a stationary Equipment PFN like the one connected to the register, computer, coke machine No.3, or audiovisual and security system No. 4. The PFNs are universal in general and handle all data relay functions. They are also programmed with the electronic Payment industry software, various commercial software packages for machine control, TRAC software and FACT programming for Homeland Security. This is detailed in FIGS. 2, 3, and 4.as well as, throughout all the related patent applications herein incorporated by reference. No. 2 Hard connection can include phone lines or cable and are illustrated in the figure as a thick solid line bordering the top right and bottom of the figure making the critical connections with the electronic payment industry servers down the center of the figure and the home offices of the retail business or the supplying manufactures depicted on the right of the FIG. No. 5. and No. 6 FACT, the Federal Access Control Technology operated by the Homeland Security Department. As detailed in FIG. 3 and throughout all the PFN/TRAC/FACT technology writings the PFNs support various wireless both short and long range and the translation software to both receive and retransmit data (Packet) to wireless gateways that connect with the IP network and can deliver the payment data or other commercial data as well as any national security data to the appropriate servers/data bases either in the center of the page or to the right or to Homeland security or local police.

No. 3 shows an equipment 1E PFN unit interfaced with the coke machine. Because the machine is powered by standard current this unit has been chosen to function as another relay station, either as a backup or redundant function in case the register or building management PFN fails, or to automate the entire establishment or building and eliminate the cash register-leaving only staff to clean and refill with automated loaders and robotics if so desired. This equipment PFN in the coke machine can have a hardwire connection and or be wireless with a Cellular ESN and phone number to make contact with a wireless gateway and IP servers.

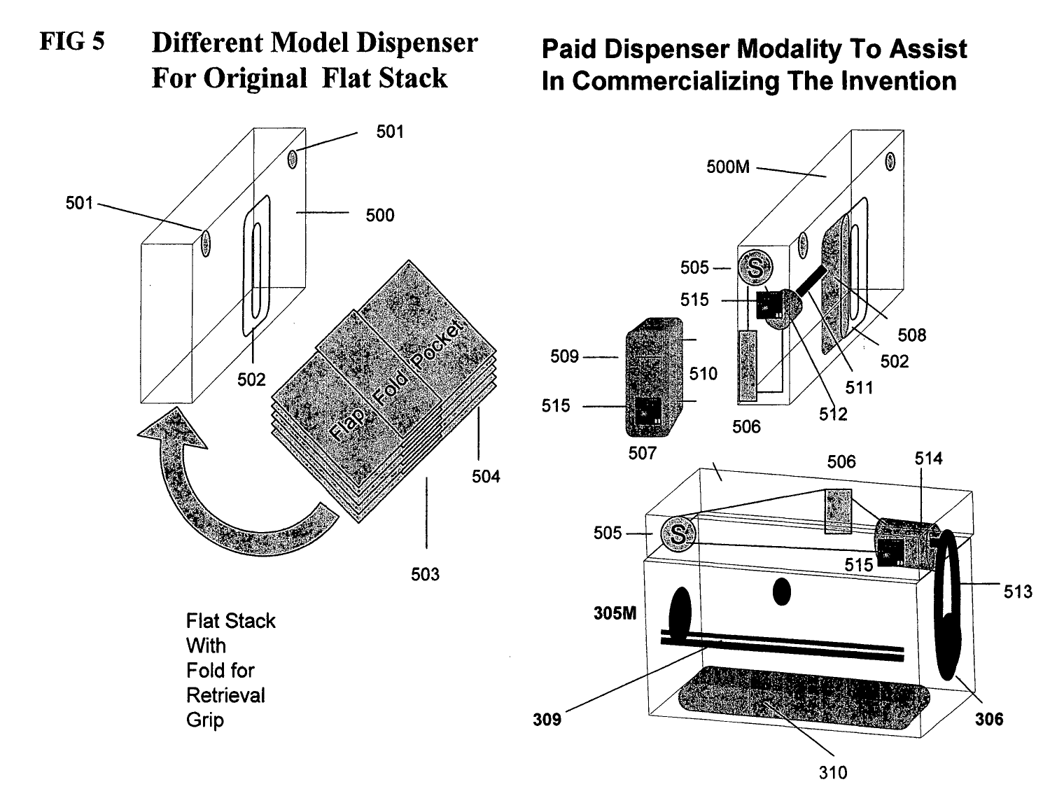

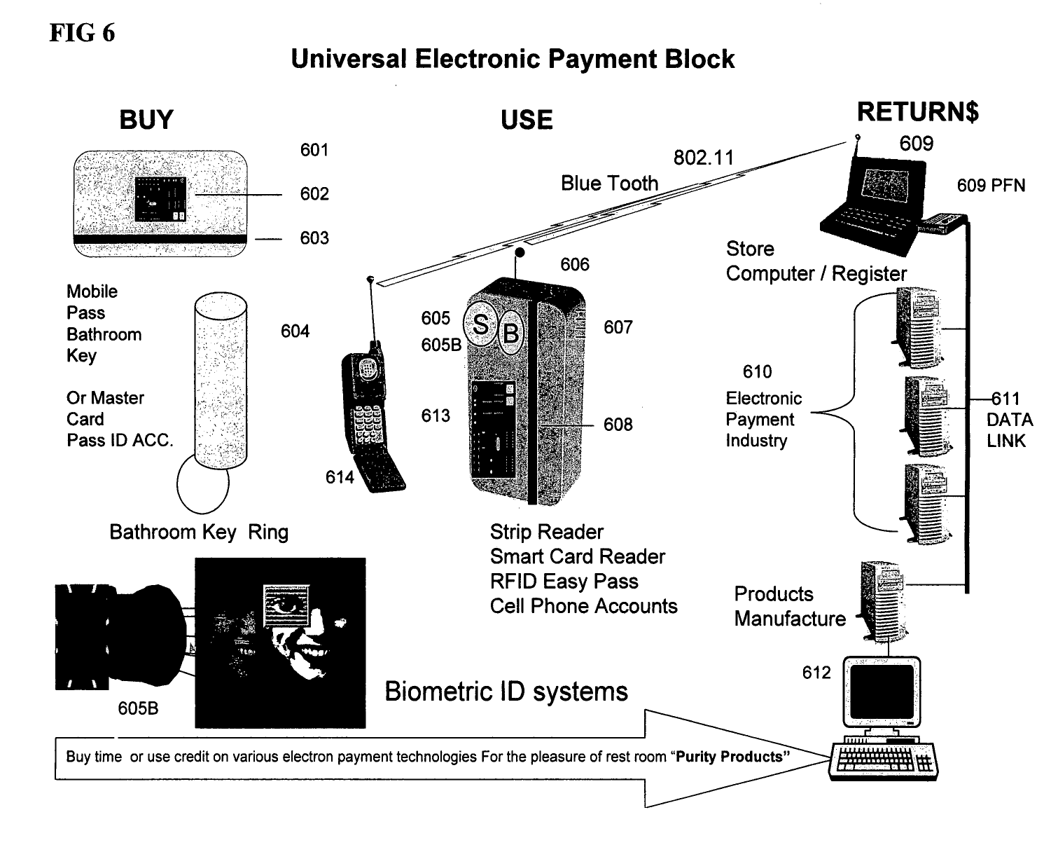

No. 4 shows a PFN interfaced with a Video System and or audio recording equipment and or as part of a building security system. This can be a complete set of security functions or part of any PFN or even done by the smaller PS1 for that mater. However, presently the amount of functions are encumbered by battery power operation so the more universal the more in the architecture of the complete PFN. Anyone of the machines shown in the left column could support a PFN and function as the Stores Financial Node. A master slave relationship and a sequential order of master slave is preprogrammed into all PFNS and all PFNs are Master to all PS1 units. PFN and PS1 Units have sensor, scanner, Readers and receivers, mini transceivers or specialized antenna to receive transaction data from all the various electronic payment technologies. This is further detailed in FIGS. 5 and 6 and the related technology. As SOC technology improves and power sources become more efficient the complete PFN could very well reduce to a size smaller than the smallest PS1 or small chips to day.

No. 8, 1PS is a personal PFN and can be an attendants unit for local remote control over all the equipment and or a direct connect with corporate and the electronic payment industry. These personal PFNs are detailed in the related patent applications and herein incorporated by reference. However, each PFN can support a complete HMI human machine interface for any and all electronic transactions. It is a complete electronic terminal and being infringed on by the wireless phone industry and PDA products.

No. 7 Shows a wireless laptop connection made possible through the PFN in the register or either of the other two PFNs via Blue tooth or an 802.11 technology/transceivers, or could be any broad band communication. In fact, PFN terminals have been invented to perform this repeating connection and are being infringed on by a host of companies that do this function for specific applications. They need PFN/TRAC licensing and upgrading to perform in a national FACT security Matrix for the Department of Homeland Security as well as provide more in a universal payment capacity. It is encourage that all such technologies to contact and make arrangements to legally license the appropriate rights and coordinate their data streams to do what they are doing more completely and legally. Ultimately, everyone should work together to serve the market and society well.

No. 9 Deals with wireless Cellular Phones, PDAs and devices that employ Blue tooth and 802.11 technology that can make direct short range wireless connection to the internet through the PFNs as well as, purchase product on their personal phone accounts from this automated store concept. Software in both phone and PFN allow the user to identify a purchase and confirm a transaction through key pad voice recognition and interactive displays as detailed throughout the related patent applications and incorporated herein by reference.

No. 10 Gas pumps using Mobile pass that processes charges to a particular credit card can do the same though the PFN and PS1 sensor/reader receiver universal array and they can use them on other PS1 and PFN equipment interfaced. RFID technology is read via the PFN and PS1 universal arrays.

No. 5 Shows the manufacturers like Coke, food manufacturers that might want to prepare product for automated machine vending, a company like Fort Howard that make paper products for public restrooms and a store, home office or corporate office like for a 7-11 chain etc.
As product is purchased to the left (in figure) at the store or commercial vending level financial data is sent to the appropriate electronic payment industry server for instant approval (a process that updates rapid approval by rating the consumer and augmenting that status on their payment device to speed up transaction approval).
Additionally, a corporate office can be notified of the sale of product level of stock providing real-time inventory to replenish the inventory sold.
Manufacturers can be notified with contract in place to process necessary inventory for a wholesaler or business and ship directly to store location or building.
And this way product can be sold on consignment, where a product can be stocked into a buildings restroom and the machine reports on the use of the product and the lot so that the manufacturer is paid directly from the electronic payment industry and building maintenance does not have to pay for the product nor inventory it, or order it and not even load it in when the restroom vending machine reports it is time to refill the machine to the building management PFN or register the manufacturer knows as well (but both are notified for accountability). This information can be delivered to the manufacturer and they can communicate with the Building Manager or owner of the establishment or vice versa.

No 6. Federal Access Control Technology FACT is detailed in the related patent applications and herein incorporated by reference with this application. Every processor can have a FACT software or firmware program or other security program that is responsive to a master FACT computer Server and Data base operated by federal agencies that regulate the specific machinery (industry related regulation and equipment registries for federal access and control technology) and DHS. Regional federal agencies have responsive FACT Registries with ESN numbers for the PS1 and PFN units that are interfaced to include any equipment controller's ESN data in their area. These registries and or national registries are accessible by local law enforcement and first responders (optionally through direct contact and or wireless querries of the machine interfaces or mass data systems). All access is tracked and recorded locally and through the entire FACT matrix and accessible to only those with appropriate credentials (determined by rule, regulations, code, law, procedures, and protocols). These personnel/Department/Agencies up to and including Department of Homeland Security DHS can query any processor and data storage in the PFN/TRAC/FACT System and enter process searches for explicit product and personal activities (any portion of this process done out side without licensing of this technology is an infringement). These preprogrammed searches will generate FACT alerts that are retuned back to the authorized search authority and or DHS. There are very strict uses and application outlined for this activity throughout the related Technology and incorporated herein by reference.

FIG. 2

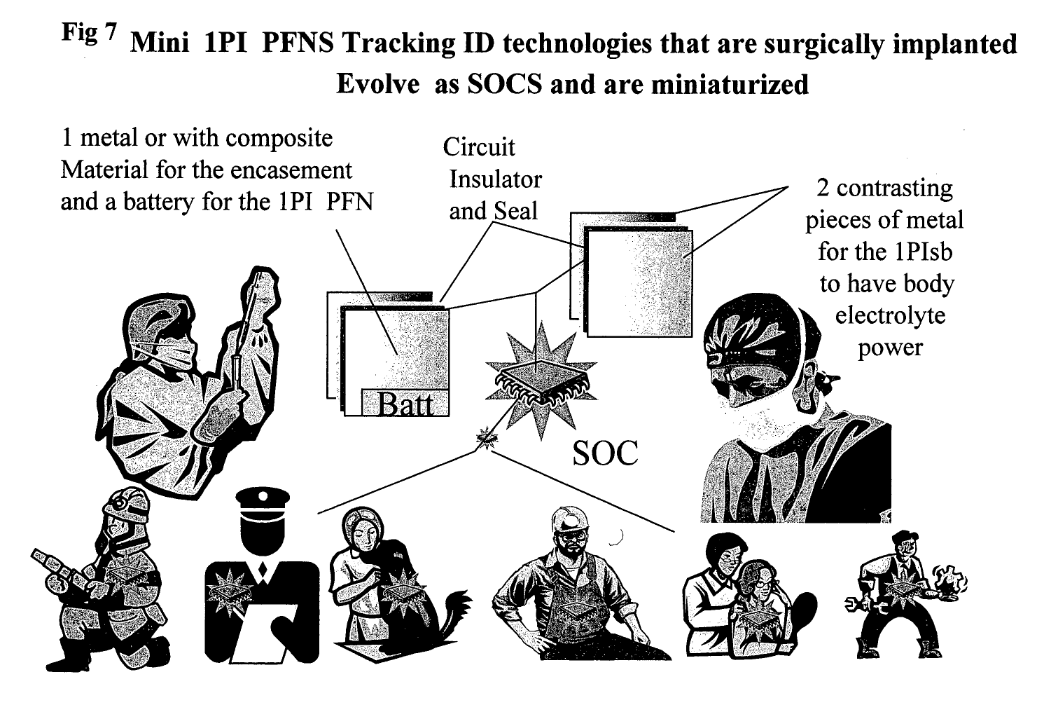

The Figure above Shows the credit card slot for a machine PS1 or 1E PFN with a display face on the front of the machine, the palm or finger scan reader interface and an encased PS1 or mini PFN next to people using their wireless phones PDAS etc. to order lunch out of an automated delivery system to the right where a lady is loading the food dispenser. Below is the encased protected circuit for the PS1 . To the left down the side displays a lot of the personal biometrics the PS1 is set up to monitor and report and record via a tight fitting close and suits and even support physically Imbedded transmissions from PS1 I or 1PI PFNs detailed in FIG. 7. The technology is destine to move to more biometric ID indicators as time goes on and the recognition of this and further discussion throughout the related patent applications make all advancements contemplated and inherent to the PFN/TRAC/FACT system and the electronic payment industry application.

Also down the left is an interfaced Keypad to input personal PIN numbers and to the right side Audio visual interfacing to support voice recognition technology and visual identification scanning. To the left of the machine messaging interfacing and below the silicon relays for out put control of machine actuators not directly interfaced with a machine controller are the PS1 or mini PFN (the controller can serve as the machines sole controller. Further down is the emergency battery a transformer left from normal building current to recharge the E- battery and operate the unit. Because of limited space in the I/O section the processor has the mode device that are connected and their drivers and software are interfaced to include readers, scanners and sensors (an optional plug and play capacity for greater device interface is an alternate modality). Unlike most of the PS1 stand alone systems all PS1 or mini PFNs attached to machinery have continual power and capable of handling more interfacing and multiple applications. The future is bringing more systems on a chip or SOC technology with requires less current to perform many more processes and store much more data, which is driving the difference between the PS1 and PFN platform into more of the same design.

In most descriptions of the PS1 there is normally only one dedicated short range communication DSRC technology, however the capacity exists to support and interface additional wireless. Plug and play memory devices are also detailed through out the PFN/TRAC/FACT system and will be accessory developments relative to efficiency and capacity per size and power considerations.

All the technology is detailed for the PS1 and PFN to operate in this fashion for the electronic payment industry. The following descriptions are relative to the present applications, but from other application descriptions for the PS1 platform, they cover all technical material necessary for the development of this application. Some involve home applications and other industries as well as the government security application(optionally called FACT.

PFN/TRAC System: Home Management

Attributes and Applications:

Home/Store or business PFN/TRAC systems will be comprised of at least one universal Primary Focal Node (PFN) capable of communicating with machinery, computers, personal PFNS and other specific PFNS through wire or wireless means, creating an intranet/ Ethernet and including IP protocols and Internet connections. As in all applications, the universal PFN/TRAC System provides a versatile organizational interface platform using the five “Ps” in PFN Technology: Protect, Preserve, Plug, Play and Program to accountably integrate components and systems. Electronic systems and components available to potentially integrate and connect with the PFN/TRAC System include: phone land lines, power line communication technologies, wireless telephony, wireless light communication systems, fiber-optics, machine messaging, security systems, satellite TV systems, cable TV systems, audio and video systems, utility management & billing systems, Internet providers and servers, radio frequency equipment and paging systems.

Commercial Potential:

Equipment Systems Include

IP—OEM appliance interfaces, home security system interface, house/vehicle systems interface to include but not limited to emergency power and phones, energy management and utility monitoring, Computer interfaces, transponder and locator technologies and interface for home & personal assets inventory, TV and audio systems interface and supporting an IP user terminal.

Personal systems include but not limited to:

Personal locating technology of the PS1 /PFN units include applications to track and provide telemetry on children, skiers, swimmers, hunters, adventurers, pet tracking—identity confirmation—health care monitoring and administration, etc. The following is an ASIC circuit for use in a home appliance or electrical device with the power considerations changed to meet host application. Further Smart Home Management, Design Lighting and Security Systems is covered in appendices II, III VIII of prior 10/975,109 and incorporated here in by reference.

This Application Specific Integrated Circuit can be a Commercial Off The Shelf COTS component or constructed from COTS components or be completely proprietary and manufactured in accordance with drawing five (all of which fall within the nature and scope of the invention). The first block of electrical components the biometric sensor section. The sensors include, Heart Rate, Blood Pressure (BP), Respiration Per minute counter, Blood O2, Co2 sensor, EKG Recording Signals and any Arbitrary Biometric sensor capable of sign/data generation and processing by the ASIC running application software (determined by the applications requirements). The circuit is designed to handle machine language as detailed in implementation to be forward engineered for future biometric sensing and personal devices. All proprietary sensors with hard wire connections are to be plug and play capable with the appropriate/standard high reliable water tight connections. And additionally wireless sensors will use via Dedicated Short Range Communications DSRC (FM) communication appropriate for the application (e.g. FCC 5. GHZ or 915 MHZ. Are some COTS possibilities but not to be limited to). These are examples only, any frequency/signal that can accommodate the data requirements from the sensor sending to the local processor receiving and running software, or to meet remote monitoring requirements is acceptable and considered to fall within the nature and scope of the invention. The local controller unit has a lighted LCD display to read information with a keypad to prompt and query the system. A water proof clip on display and keyboard-number pad interface package is a possibility that connects either by wireless or cable to the local controller/Processor. Audio and voice command and voice recognition are other interfaces contemplated as well as digital camera and a broad enough signal band to carry the data. These interfaces would be in the machine messaging interface section and use appropriate machine language as detailed and available in COTS software and prior related filings incorporated herein by reference. Also, programming mediums like CD players, various disk technology and MP3 storage devices would be connected by standard reliable connectors and interfaces at this same point as storage devices and other means to deliver software. The drawing size does not permit for all the machine and biometric interfaces to be illustrated clearly listed so they are further detailed in the text portion and other drawings in the related prior filings incorporated here in by reference.

The second machine messaging set of interfaces will vary from machine to machine in the connections used. As time goes on these will be part of every machine purchased and rarely add on accessories. However, their will be a connection block to add new equipment sensing and the manufacture will be able to reprogram the local processor via a phone line connection (J-15) connector or cellular interface if one is connected or embedded in the electrical system or by standard download mediums or other dedicated short range communications DSRC. The control modules per machine will reside in appropriate protective enclosures optionally with a clear transparent window to view the display with a flexible water proof (possible blister pack cover) for individual data entry on a keypad (locally). And, further provided any appropriate water tight encasement with any necessary o ring seal and boots for hardwire connections (or appropriate rough service containments application specific by industry or government code, rule, specification, regulation, or law). Appropriate application specific sensors for operation, tamper detection sensors, over load sensors circuit and component sensing diagnostic sensors and programming audio and video monitoring will be some of the standard operating data generated by individual equipment interfaced with the PS1 and system wide PFNs as part of the electrical sensing system processed by the programmable processor/controller)with data stored and compared to evaluate that equipment and total complexes are operating within normal parameters). Sensors are being perfected inexpensively today for the homeland security initiatives and will be available in the future for public safety hazards as well as national security. The invention is to be forward engineered to take advantage of these developments and be able to inherent their enhancements within the nature and scope of this invention as detailed in this specification and throughout all the prior filings but most importantly referenced in 10/975,109 and all its appendices.

The dotted line indicates the circuit is to be encased in the appropriate level of protective structure and properly insulated and grounded. In the containment the processor is to have its own backup power supply in a rechargable Ni Cad or lithium battery of sufficient capacity to operate the security and safety protocols and operation requirements for a minimal time if the power is compromised. The emergency power in the containment is to control all functions for a period with warning and safety and security for an additional period. The emergency power system is to be as good as needed and commercially practical and it is to be forward engineered to utilize the latest developments in power storage technology or electrical generation to include but not limited to room temperature supper conductors, and use any and all forms of present re-generable energy (solar, wind, etc). The processor can be configured from COTS products or specifically designed from the circuit design and text writings. This is further detailed in the implementation. The most important point is practical functionality per application and reasonable cost. A wide technology description is made in the implementation and further elaborated on in the prior related patents and protected filings with the most inclusive and concentrated technical writing in the 10/975,109 filing (incorporated herein by reference:

IMPLEMENTATION may be accomplished in many ways, depending on space or funding constraints and level of integration required for the system to control and to route. With cost in mind A micro processor/ mini computer (PCU) or (PC 104) or a Systems On a Chip(SOC) evolution embedded with a dedicated DOS or Windows based program, consisting of machine language, Basic, C, C++, Visual Basic, Visual C or C++, or other high level language which accomplishes the function through software control. Interfaces to the System Under Control (SUC) may be accomplished through appropriate I/O cards, either analog or digital, plug and play chipsets with protocols in firmware and compatible connectables.

The wireless Interfaces To include PC compatible Modems and or Cellular phone interfaces high speed internet, (via proper connectables and or band width transceiver/ receiver chipset and antenna architecture) to provide the interface for a Remote Monitoring System (RMS), and or management system. SUC and RMS interfaces may be in the form of ISA, PCI, PCMCIA, VME, Compact PCI, Future Buss, or any other relevant commercial or governmental interfaces compatible with the PC-based system used. More compact and custom implementations of the ASIC may consist of dedicated state machine controller implementations in which the functions are executed through embedded firmware. These implementations may incorporate multi-chip or hybrid chip/innovative interface solutions using EPROM or EEPROM interfaced to Arithmetic Logic Units (ALU) (SOC), I/O ports and discrete memory elements. They may also be microprocessor or microcomputer based. A large variety of board level products are commercially available for such an implementation. Single chip or high density implementations might consist of Field Programmable Gate Array (FPGA) or Application Specific Integrated Circuit (ASIC) based devices and Systems On a Chip or SOC technology. Additionally, the different wireless protocols can be in hybrid chipsets and firmware on Plug and play (Using PC104 architecture or any newer condensed architecture like SOC technology), interface boards or I/O cards and would be developed from developer kits provided from the 18 most frequently used wireless telephony protocols on any wireless RF protocols for long range, short range, broad band or narrow band. All implementations may incorporate all sequencer, firmware, I/O and storage functions on a single device and would provide the highest level of integration and smallest size. Display, Video and Audio (Auxiliary Data) for the programs can be in many forms and types to meet the needs of a single PS1 or PFN unit application to a Multi- screen computer controlled display or displays to provide display or individual displays in a central control or command center. The memory technology may range from analog systems, in which tape or other magnetic media store the analog signal, to digital systems in which data is stored on hard disks, EEPROM or RAM or the myriad of new storage mediums(For forward and backward engineering and to make a universal and large system as quick and reliable as possible). Some PFNs sole function will be as permanent or temporary system interface computers between disparate systems and technologies Therefore, data format may be modulated through UHF VHF FM or AM, compressed, packet or otherwise encoded for reduced bandwidth or expanded for transmission over the Internet (as packet data). Signal and data handling In some specific PS1 and PFNs are to provide the processing power for an evolution of multiple modulation syncing, AD,DA conversion, translation and data processing at higher IP stack levels and or in SOC chip sets via appropriate firmware to perform these tasks more universally at many more locations in the future with the cost driven down by economy of scale and more universal translation software (vocabularies).

Hardware Implementation are to be progressive and flexible first COTS Based Mini computer PC- Programmable Controller (PC104)-Custom Logic Sequencer μP (Micro processor) FPGA (Field Programmable Gate Array) Custom Gate Array (ASICs) Systems On a Chip (SOC)

Features Uses “Industry Standard” Interfaces, it is Programmable & Modular, Scaleable, provides Level of Redundancy, Event Storage, Algorithm Type Software, Security, Commercial: 128/64 or 256 bit Encryption (Web Transaction), IEEE Standardization, Computer Standardization, H-Rel Connectors, Actuators, Sensors, Signal Levels

Dedicated RF and Wireless Telephony and data interfaces Short range FM, Digital Cellular, PCS, 56K Modem, RF & Pager Technology, all the approved DSRCS, a framework for passing configuration information to hosts on a TCP/IP network (application level translation from machine language to wireless protocols to IP Protocols, Time of Day Protocol [RFC], to obtain the time of day, Data or network, Edge or access routing, DSP medium, RF medium (coax, modulator/demodulator, antenna), RF management software

Remote monitoring out side the containment show the communication mediums Laptop and PCS connected either by short range wireless or long range wireless and telephony depending on application and need, and the further connectability of the Web to send the data to other specific addresses. The personal data and commercial augmentation software for the pool operation is to be encrypted with (PGP).

FIG. 3

This diagram has been used in all the PFN/TRAC filings to show the basic circuit design. Additionally, taught in this figure is the separate processing of TRAC or general commercial data and FACT the National Security data program and equipment command structure. All the technology to retrieve and process the present disparate payment industry data in a more universal manner and repeat that data via a secure electronic architecture is taught in the following description of this PFN ASIC.

This flexible Ethernet set of interfaces make available so many access points between the local PS1 and PFN platforms—it creates a universal payment instrument locally for all kinds of electronic payment technologies. Also, the coordinate and local processing makes the process more efficient for the various networks, but additionally develops local commercial data for business management, and a level of visibility into local life in an instant and comparable to a norm in real-time never before available to any national security mission (just in time for DHS in the US that must function in a free society that must respect individual rights).

With this reality recognized early on the technology was designed to maintain accountability for all of its uses and maintains local and network data storage with individual identity, equipment employed, time and location of all trans-actual data (2 sets of records) (strict and professional handling of the material is taught, and prescribed, and an adherence to constitutional law with no exceptions, including the President of the United State not being above the proper use and proper handling of data for an reason (which includes respect for the FISA Act in its total application specifically- directed to address A Chief Executive that has kingdom tendencies and loses sight of presiding). The technology also teaches a claimed process to utilize randomly selected regular citizens through a process operated in each of the 3 branches of government to pick these regular citizens/reviewers—which are intern then specifically educated to review a specific isolated national security data incident in question, and determine if it is truly a national security at risk, or merely an embarrassment or might deserve some other course of action, etc. (The power is from the people and the People are the final check in our balance of Power- not our elected representatives, and fortunately now we have the technology to make this efficient and safe for all of us).

Returning to the circuit diagram—it shows the standard wireless interfaces for all the surface applications to include 1SV PFN for surface vehicles, the progressive direction of the DRCPFN interface program with present vehicle Telematics (and the infringements from the automobile and wireless telephone industry, the 1E equipment for stationary machines and 1Ps PFN 1P for the personal PFN processors. Even a 1Ps standalone unit could be as sophisticated and support as many multiple wireless technologies and route between them as possible for the size desired to technology ratio and efficient power source to size and weight technology available. They could range from very simple tracking operations and ID telemetry to extremely sophisticated robotics processing and communication routing. However, in this application these ASICs are the supporting substations and repeaters for the 1Ps Tainer talker. It system can include whatever wireless is privately chosen or agreed upon as a standard for specific application. Obviously, some decisions are made from a physics consideration when choosing and approving frequency/wavelength for application by the FCC commission, but far to often commercial influence and power rule the airways, a queer governing policy arrangement for a free nation, This is why throughout all the PFN technology writings at least one of a multiple frequencies and communication technologies is responsively interfaced allowing for all applications to be included no mater how rational or irrational the choice of communication technology from the monetarily lobbied governance. This too, is why PFN technology also claim universal antenna configurations both proprietary and COTS. In fact one of the major applications for the PFN is the translation between communication systems so that they can be used in singular applications or cross combined as is the current need for Homeland Security to link first Responders wireless communications.

The ASIC in FIG. 3 may appear the same in wireless interface but differs by machine application and control function if not solely employed as a communication router. Additionally, it is different in how it derives power as well. With 1E PFN/TRAC units being energized by AC house or building current which is transformed to computer control voltages and service current to drive silicon relays, motor starts and high low voltage solenoids or as interfaced with a host machines E/E system (and any existing OEM controller/operational program) to perform remote and automated activities controls on that host piece of equipment (or separately connected to actuators different or in parallel as a redundant system or master control system. These 1 E PFN controller routers are used on stationary equipment applications in and around ports, airports, stations, automated roadways railways, border crossings and toll gateways, automated businesses, manufacturing and stores to interface and control conveyor belts, cranes, escalators, elevators, scales, scanners, metal detectors, baggage handling systems, automated ramps, pumps, vending machines, manufacturing equipment, waste and coal gasification equipment, grain, spice, powders or dry good vacuum systems, lighting systems, video units, digital and analog and also receive weaker signals or other PFN signals and repeat them as per programming either in other commercial messaging like TRAC programming or high security (possibly encrypted FACT high security messages.

Regular TRAC or commercial messaging would include commerce applications for automated vending and the relaying of short range PS1 driven payment readers and scanners, or those directly connected to the PFN/TRAC circuit displayed in this figure These PFN/TRAC applications are well documented in the 10+prior PFN related patent filings. The circuits and the specific control function on the equipment are detailed more extensively in these earlier filings and apply by reference to the specific programming and vending application. Also covered in this application is the router relay translator function of the PFN and, later covered a mini piggy back translator PS1 package for existing First Responder radios.

The figure has a darker shaded squares and cubes and a lighter shaded larger area from the center to the left generally. This is actuality because the darker areas are actually deep red in color and the lighter shade is a powder blue. This is to delineate secure communications characteristic much the same as the classic orange and blue used for military high security encryption in DES meaning Data Encrypted Standard.

The shading is acceptable for delineation in the patent process and the color is immediately recognizable in the ART, industry and government.

DES circuits are what they call orange and blue or red and blue. The red is generally an isolated circuit (hardware and with encrypted software and shaded more in the figure) and the blue is of less secure data and may have PGP pretty good protection or none at all. The actual security sophistication must be determined however this teaching and the eleven related filings lays out the options and the innovative embodiments to implement any choice. And the choices are numerable in the security and encryption programming both commercially and governmentally. FACT

Programming is completely detailed throughout the earlier applications and incorporated herein by reference. So the discussion in this application will be towards the most sophisticated and progression to get to implement FACT communication links to broadly employ rapid sensing and deliver accountable commands back to any critical Prime mover PFNs (As an automated response to keep humans out of harms way). Not to much time is spent on what automated response are possible as these have been well documented in other related filings and will equally apply to vending machines as far as there operations can be utilized in thwarting a threat.

As explained earlier the circuit may be completely created or just developed in part for an application specific purpose. To complete a portable sensing web or network. It could be on any kind of prime mover or piece of equipment and serve the net as part of a smart cell for any individual network. A prime mover is a vehicle, boat, plane person, animal object or stationary piece of equipment, etc. that is self powered to provide a stable energy source for the protected PFN/TRAC/router unit, to operate as a relay substation as well as, a primary focal node to control a machine's electrical and electronic systems. Most objects, people and animals incapable today of providing sustainable consistent power would utilize the smaller more defined in applications PS1 HS1 1Ps platforms detailed in Figure two.

Any combination of wireless technologies may be employed in any number of configurations of PFN/TRAC units with Translation programming between the wireless protocols as required. Because they are wireless they can be reprogrammed in the field and changed in mission. Broad Band technologies/frequencies will be chosen as much as possible to make this process as efficient and speedy as possible. Obviously as the PFN/TRAC system architecture becomes more accepted as a interface platform to improve movement management and security vial voice over data and machine messaging there will be more refined and defined programming and standards simplifying the process and making it more efficient.

However, one purpose of the architecture is to create the mechanism to evaluate and progressively achieve a universal messaging interface to include cross application and cross environmental wireless products in an effort to coordinate safe and secure movement of machines and people on or near the earth's surface. Because, this basic ASIC for the PFN design is a guide and local point of fusion and merging of these technologies it will be referred to in the various application and configurations to describe the interactive process the architecture is to perform. And not at just a network level but locally for immediate efficiency and ultimately greater reporting to all responsive networks. Any absence or lack to mention any application is unintentional In no way should the reader assume that the technology is limited to the examples explored in the specific filings or applications. It is essential that the reader understand the total and complete intention for the invention and tits inclusiveness of all data generated to provide a safe and secure movement management system and machine messaging interface as well as, a stable and reliable communication technology. All the sensing, monitoring messaging, machine control, communication routing translation and relaying, the PFN/TRAC System and FACT Security Program is designed to manage is to maintain a healthy earth environment project and automate safe movement, account for the resource and equipment use of resource and impact of such use on the globe while promoting understanding and an economy that provisions the masses fairly and justly. This is the complete nature and scope of the invention to optimally serve humanity's existence and humanities individual awareness. By design the technology is designed for economical local interfacing to expand the economy and grow all businesses through inexpensively licensing and a direction of collaborative efforts. Through an expanding economy cooperation could be even more profitable than head to head competition. But, for this kind of smart business to occur humanity has grow into with this technology and use what it provides well with each other, or it will have the same degenerative business cycle as all our present limited economic experiences that are plagued by recessions and even depressions, when scarcities are unnecessarily caused or deliberately created for personal gain, private interest or accurately called national or American interests (It is just business as usual for the oil business but an economy the world has had to survive through for the last 140 years.

With that Stated, a Return to the Nuts and Bolts to Improve the Quality of Life for Humanity

The figure shows 1SV PFN will have much of the same wireless as the other PFNs and especially in and around the airports and other mass movement areas. The 1P personal PFN/PDA or IP PFN Belts or wireless phone infringements on the Primary Focal Node or 1E PFN for a piece of equipment will have wireless interfaces much the same as is illustrated for a port or harbor. This is especially true for cities like New York where Kennedy air port and the harbor are run by the same management authority like the New York port authority. At least for the security and police wireless will share direct links or should have that capacity and that is what is illustrated in this figure. The great part of the PFN/TRAC unit is they do not have to be and in the beginning will not be contiguous(they can be different from one network to another and be converted through a Plug, play and program or wireless down loads or made to interface with other processors and wireless applications later- or alter existing processors and wireless via these same modalities). Below the wireless inputs to include a GPS receiver or other locating technology is the multi-pin connector or interface to connect up to the automobile CAN bus system and or drive direct connections to actuators and service power control circuits for activity controls on a vehicle. They will not be the same as the E/E system on each vehicle but they will conform to the On Board Data Standards OBD I,II,III J1850 and or newer CAN bus & J1939 for Trucks, etc. and or any current requirements for connectability with a machines electronics. These modular connecting components may include the multi pin docking of basic processing and hybrid chip set connections with firmware protocols for system recognition and interfacing between the various wireless or the latest technology in connectability and or wires interfacing. Also, the power requirements will be different in source, type, and transformation to energize the processor and recharge the emergency power, which is inherent in all PFN/TRAC units to provide the stable relaying platform or RC processor that makes the portable routing network possible for FACT as well. For average vehicles alone, the power to be transformed could range in DC current from 12 volts DC to 48 DC volts DC as a general rule and all different levels in mass transit platforms some may be AC as well and have to be inverted or converted and transformed to operate the PFN/TRAC processor at electronics at computer voltage levels (all such design considerations of fall within the normal skill and knowledge of the art of electrical engineering).

The circuit concept is the same for the 1P PFN and 1PS but the level of complexity varies immensely and is explained throughout the filing. The six above squares to the left in the ASIC (darker in shading) represent the interface protocols from the various wireless communication technologies that could be connected in a plug in hybrid substrate chip set and can be changed to meet the application specific need of any specific primary focal node or PFN application as expressed above. This drawing is exemplary and as just stated should not limit the reviewer or reader's perception to the amount or types of interfacing possible.

This ASIC shows a CAN Bus interfacing if used for automotive to include J1850, 1939 ISO and any of the other new LAN Vehicle Bus systems. Local clock time is updated by the GPS—Satellite or communication technologies. Tamper detection is an earlier FACT integrity check procedure detailed as a security process protocol in earlier related filings, but basically says that the PFN clocks must be synchronized to have coordinated movement of man and machine. This is accomplished through the GPS system or low earth satellites LEOs or atomic clock synchronous messaging (wireless) Most all is self explanatory in the circuit design. It is understood that systems will be consolidated via SOC technology within the nature and scope of the invention. Many types of encryption are available today (PGP, DES, the wireless payment industry has more as well. FACT is to be a security program format that code will have to be written too and the types of codecs and encryption standards for high security and commercial and private security communications as well as public statistical information protocols to de determined legally first as well as the frequencies will be decided on. The software operation and design is written in text and flow charts though out the related filings per applications. They will also have to be approved by the specific government agencies and FCC and law enforcement agencies specifically and industry standards committees (normally part of any government standard). As stated, the technology is to be constructed as a multitude of modular configuration to support the necessary options for interoperability of normally disparate wireless communications and refine and define the best combinations of these technologies for specific applications to achieve efficient movement management that is safe and secure. A Most important characteristic of the technology is the capacity of the technology to interface with present, legacy and future systems and to consolidate combine and linked circuits and systems. This maximum interface effert to combine electronic functions and management lends itself to SOC technology or systems on a Chip for future application interface and miniaturization. The real life COTS combining and SOC growth and conversion to accountable use is an important implementation of the invention and its design purpose.

Continuation of exemplary interfacing in figure four- RFID radio frequency ID program (EZ pass) and Blue tooth a short range RF technology for wireless telephones to interface with and some automotive telematics are shown and they would have either appropriate antenna configuration and reader components with the appropriate chipsets. All these technologies wish to advance their application and offer experimenter kit or prototyper kits for those skilled in the art to make prescribe the appropriate hard ware and software most current and flexible available to accommodate the necessary code with translation algorithms between the messaging protocols (Some already exist and wireless Packet data and IP data packaging is a well known computer engineering). Then these existing technologies are provided a universal interface platform via this PFN ASIC. Added to the programming and implement via appropriate interfacing chip sets is a traceable routing message headed and command string to track, identify the routing for accounting (wireless billing and accountability for the wireless sensing or people material and equipment condition and movement. (E.g. For aircraft and luggage and the compartments or containers of rail cars, ships and trucks, etc,).

FIG. 3 shows a I/O input Output block darker shade left if colored, this is to be a multipin docking station (exemplary) Page and Reflex Developer kits provide chip sets.

The Short Range Communication Functions

Each PFN/TRAC unit on any machine, ship, vehicle, aircraft and or equipment, etc will be master and control to all other carried wireless by design, via programming and DSRC of some sort, e.g. 802.11 or Blue tooth,

The exception is the carryon 1P PFN Belts or PDAs operated by authorized operators, drivers, pilots, sea captains, police, possibly Fire/Rescue/EMS, sky marshals, customs boarder patrol, DHS/FEMA, Government Officials, etc. These authorized Personal 1 P PFNs can control local wireless and communicate with all PFN equipment interfaced with special real-time authorization procedures. Otherwise the control defaults to local robotics and TSA/FACT Intranet control/Homeland security Command and control under specific protocols, or safe operation mode preprogrammed. Individuals have personal 1P PFN authorized remote control over their electronic possessions and machinery and services they pay for electronically. 1 P personal PFNs are camera phones tracking devices wireless hand held computers (PDA) either progressively, incrementally, in part or entirely and presently infringed on by the phone and wireless PDAs and handheld computers today.

The PFN or series of PFNS on board a piece of equipment vehicle/aircraft, vessel would work in harmony to identify the carryon device's via (ESN recognition and look for alerts) as well as manage their use or restrict any such use to include cellular phones and other so equipped carryon wireless as determined best for flight safety, or basically public safety and national security(herein called a FACT event). As part of this invention's nature and scope these SUC technologies and system's engineers would write code into the Application software programming to immediately transfer all PFN/FACT directives via access through any cellular service that the cellular phone service was part of for emergency action messages or EAM message delivery. EAM messages are well detailed in the prior filings but basically create an emergency vocabulary to be recognized through all the wireless protocols and passed to FACT gateways. E.g. in a business it could give a continual down feed of identifiable data packets and information for a sensed FACT situation to connected data receivers and data repositories for further data resources in real-time and for later analysis via the specific regulatory government data base/FACT intranet of mass data handling and registry storage system (thoroughly detailed in prior Filings e.g. 11248-3300). Special arrangements with the wireless providers to support secure gateways into this IP security matrix with the various government agencies for FACT and other security agency software will have to be arranged to construct the FACT system as shown and detailed in figures and text 10/975,109 These cited figures do not appropriately apply to this application, they are relevant to remote control of machinery used in air travel or transportation, however the PS1 or Personal PFNs that an attendant at the automated cafeteria of filling station would be able to communicate with the vending machines and their smart PFN connected cash register via this circuit with the appropriate programming, And the FACT program would monitor for alert flags sensed on personal purchases or specific personal IDs(through the signals generated from the host of new technologies). And other functions as applying time and address or GPS coordinates would be of course the same.

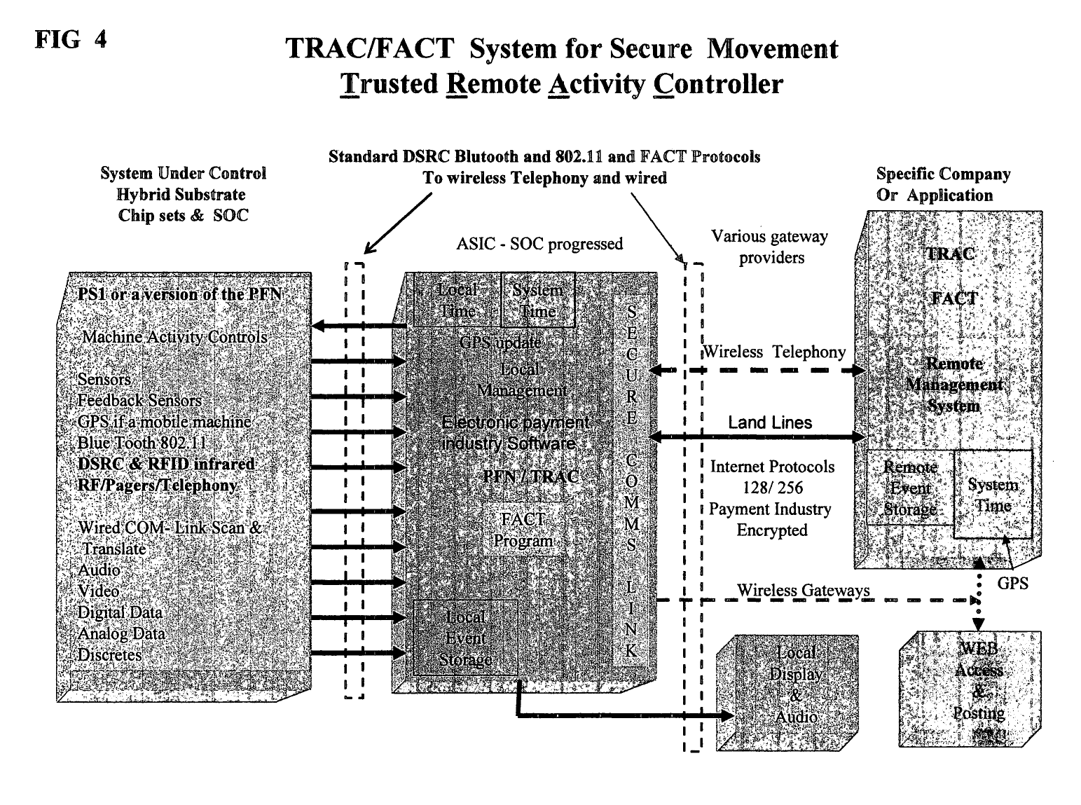

FIG. 4

This is another figure of the PFN/TRAC System and the description details the trusted remote control technology TRAC that co-inhabit the same local processor and remote IT architecture with Federal Access and Control Technology or programming and how it is setup. Even though store and business operations are other applications than that of transport and commerce movement and telemetry is the same. The reader can easily visualize the program function of electronic payment as it is addressed to pay for some of these other applications and activities whether they occur in a store or at the Airport.

This Trusted Remote Activity control process housed in the protected node PFN on a host piece of equipment is shown with a wireless set of connections to a remote management system. The management subsystem or intranet displayed here is for air transport. It could be for a credit card company, manufacture, corporate office, industrial control center as detailed in figure one of this application or like all the sub0 networks or intranets detailed throughout the technology's filing like 10/975,109. The other purpose covered in this application is for First Responders and the remote contact will include local FEMA/DHS and local emergency services Command and Control Center. The Reader can see in application 10/975,109 another four basic intranets based on the type of wireless they use and the commonality of transportation platforms involved. This has been done because the invention is a movement management system as well as, a local communication interface and relay device. The security program FACT relies on the overall homogenous interface of industry, government and the private sector management of material movement and the machinery and equipment responsible for that transport. The Technology teaches the development of registries in all the specific government agencies local, state and Federal to be part of a mass data tracking, telemetry, and record storage to be linked to materials discovery, development, product manufacture and government commercial and private use and disposal, with the real-time assembly of data and information minded from this system for FACT National Security and Public safety, through the constitution a process and protocol written into code for every application specific PFN/TRAC operation (to include the highest in the land with regard to FISA and the real-time changes like the Retro Active powers given to George W Bush after 911, but this activity must remain an accountable process and the PFN technology address that completely. The invention calls for industry and government agencies to be connected through a variety of transportation vehicles and stationary equipment. The wireless gateway severs are available through preprogramming and default setting for multiple use and are reliable consistent and can perform backup functions to insure the delivery of data to these remote data processing servers. Much of the physics have been studied, and the communication industry and telematics manufacturer have joined with even the handheld computer industry to divvy up the most ideal frequencies (Broad Band for Short range, etc) and bought them from government The FCC specifically and go about doing business infringing on this invention. But, they have not made these interfaces proficient and useful for the nation or legally, especially in how they are used today. This inventor will continue to teach the technology and the proper techniques for its legitimate use with the earnest hope that doing so smart business will catch on, rather than the sneaky stealing narrow private interest acts being done commercially and governmentally today.

In FIG. 4 the TRAC and FACT messaging is detailed for internet Protocols IP processing via the net with the advent of direct FACT gateways. The Transportation matrix and government networking in general is well covered in FIG. 23 of 10/975,109. The Trusted Remote Activity Controller/router begins in the PFN interface and initially provides local vehicle or equipment control (a vending machine) with event storage relative to the specific equipment (a running inventory-if necessary sensed data on the purchase and purchaser of an individual trans action or FACT triggered event) Being attached to and memory storage for FACT events (to include communications and command stings). This automated process can be initiated from a local PFN that flags a FACT event via resident preprogramming that has been installed locally and physically or via IP wired and or wireless packet downloads (All changes have to receive system integrity checks before local programming will accept installs as valid and complete programming or authorized changes). Security these changes are to include the latest in personal identity technology, encryption and rolling code algorithms. These changes must be recorded locally and reported to appropriate remote server(s). A local record for all FACT events is kept until the governing agency and or Homeland Security deletes it or recovers it and stores it in a number of ways through out the system (basically checks the data for consistency with second and multiple recording). The recording process is redundant via reporting to the remote management system in real-time or near real time as well as recording the event locally as illustrated from the center to the right bock in the figure. The local PFN/TRAC routing unit just discussed in figure four interfaces any number of RF, wired or other wireless mediums to include one and or two way paging systems (like Flex, Reflex, RIM and ERMIES if this messaging proves cost effective or necessary) to deliver data to the remote TRAC and FACT monitoring systems (via EAM messaging that is constructed with a universal emergency vocabulary- if this is the only way to get a remote signal and identity data delivered- or if desired). Obviously today more sophisticated links are possible eclipsing analog like digital cellular CDMA and TDMA STDMA (aviation specific cellular) all the PCS (Personal Communication Systems) or application specific wireless RF, Satellite, and DSRC RF, RFID, IrDa and acoustical technologies. These numerous communications interface at the second or third level in the present commercial cable and wireless OS routing stack for packet data and via a resident PFN translation program with algorithms to harmonize the different wireless protocols at a higher application level route signal further across a myriad of wireless options in each of the PFN/TRAC units. Routing for FACT is diverse and dispersed and confirmed as a general rule to insure data delivery, and its completeness. It is coordinated with the system clock synchronization (standardized) by LEO satellites (Like GPS) RF atomic clock signal and can have a comparator program to check and confirm time. Construction of this software program is done by those skilled in the art of telecommunication with routing accomplished via programming skilled in the art using the developer kits available for each of these commercial communication protocols.

This process has been detailed through out the related filings and chosen specifically to rectify the ills and deficiencies of free marketing disparate communication technologies by incorporating these existing and legacy technologies via universal local accountable routing to provide the most rapid progression to a much needed national security system interface of data streams.

It is called a Primary Focal Node because it accomplishes this locally as a interface node. And Like a mini-nerve center the PFNode performs automatically like a nerve reacts autonomically and cerebrally by processing data locally and communicating it to many other processors (saving time). And additionally as the center for local messaging it controls the machinery it is connected like brain from resident programming or because it was requested to do so in a particular manned by an authorized person. Finally, it remembers records and reports all. At the local level regular routing is determined as per the nature of the messaging. For example; standard operational TRAC messages are handled in regular industry specific formatting that is relevant to the commercial wireless provider and software management program running operationally. Normal accounting and communication control pathways are predetermined by commercial agreements for equipment, material management and necessary human machine interfacing (to include commercial contracts, etc.). The PFN will provide service and function data accounting through these existing pathways or to other location by authorized requests with the new delivery stings and IP addresses. And, if a local PFN FACT program flags a FACT event the communication links are direct to the first responders, and FACT specific intranets, DHS, FEMA or the managing government agency operating the control center and the relevant government agencies best suited, trained and equipped to deal with the event.

Typically, a Remote Management System or specific PFN unit could initiate a TRAC or FACT function (bi-directionally locally and via the PFN/TRAC/FACT system remote signal). This might result in the unique and proprietary controlled shut down sequences (Detailed in related filings per equipment the majority in Patent 300 & 111348-3300) and can be as involved or intricate as; “The automated guidance control, slow, stop and secure sequence” involving terrestrial vehicles, machines, ships, material handing equipment Rail and even aircraft on the tarmac (which may occur from a simple single page command delivered to a local PFN unit, or as a result of complex data processing either in a local PFN or a controlling PC or any of a number of authorized FACT system intranet terminals interfaced or any number of wireless modalities. The signal or command is received securely and encrypted then either decoded by TRAC commercial programming for standard operational management and monitored by FACT via a preprogram triggered alert flag that provides decrypted material to FACT federal access and control programming. The flag can generate a simple message with specific encoding and encryption (e.g. radiation alert sent by the HS1 “Tainertalker” units) as a FACT event. Or be a complex report from many sensors responsively connected to one universal PFN.

Signals either generated from resident programming or received from a remote location involving the operation of equipment like, the slow stop and secure robotics for vehicles would have safe completion programming and total recording of the event (e.g. truck and container in a tunnel or an aircraft in the sky Ref).

Robotics systems generally handle the safe operation with direct remote control and the best actions would be a combination of preplanning, training preprogramming as well as, real-time RC handling of the equipment and situation (Ideally, locally monitored and managed but also with the option of greater real-time robotics and satellite RC links).

TRAC Trusted Remote Activity Control

Optionally, local displays or audio speakers may provide local status of normal TRAC functions and unusual functions to be flagged as/FACT events. These are determined as these functions are executed, and provide a local operator feedback relative to the progress of normal operations(unless preprogrammed otherwise for some reason). In performing normal functions, all activity controls are initiated by the TRAC and monitored by the TRAC from start to finish. This is normal TRAC management and why the FACT security program marries so well to the PFN/TRAC System™) for local management and aggressive remote control.

Accountable accurate aggressive remote control is accomplished through feedback sensors. This data is also made process-able via sub programming to the trusted remote controller to effect preprogrammed optimal safety responses to a changing event, that has been anticipated as well as, host an analytical algorithm to create the safest robotics response. This is part of the forward engineering anticipated for the invention and all its applications. Additionally, the TRAC interfaces with plug play and program connectable technology to drive the system and process, additional sensor data and other wireless communications to include audio and video. Sensors may be electrical, mechanical, fiber optic, infrared or other technologies. Since the function being performed requires a high level of accountability and trust that the sequence was in fact executed properly, every step of the process is monitored through appropriate feedback sensors and programming to attain the reliability and trust required for system acceptance by all stake holders for normal TRAC functions but especially for FACT related activities (stakeholders; the public, private industry and government). This capability is essential for the two new applications involving the electron payment industry and the first responder radio interface. TRAC secure processing and protected architecture makes it perfect to run the various electronic payment protocols and its universal interface qualities make it an ideal platform to host these technologies. It also provides personal identity and responsibility to the actions and functions of machinery, material and products at a level that will serve public safety and national security more efficiently than imaginable (obviously the constitutional safe guards have to be in place and can be more accountably than ever).

This positive feedback and event memory in the TRAC is the key feature which distinguishes the TRAC from other electronic controllers and software. This makes a “trusted” system for the task being accomplished. To be a fully trusted system to function for public safety and national security it has to be adopted as a standard and has been planned with this in mind since 1994. This is also why it teaches COTS combinations and interfacing with as many existing technologies as possible and structures an inexpensive licensing to insure inclusion and cooperation.

All events and status relative to the function are recorded locally in the local memory storage a characteristic component of the PFN. With respect to TRAC processing purely for private industry this has been optional, but planned permanent for the increasing incidence of shared equipment control with man and machine.

However, since 911 more and more movement functions are critical to FACT Security. So this is part of the system in general. This amount of redundant memory and specialized feedback verifying activities is to make the process trusted and accountable. These requirements may be regulated and approved by local or federal law enforcement or insurance agencies, or the World Bank or US Banking industry, EPA, ICC, SEC, FAA, FCC FBI, DOD, DOT, TSA, DOE or any other regulatory agency. One goal for the PFN/TRAC unit and system is to have this protected universal routing processor and equipment remote controller standardized for these industry and government movement and communication applications as the requirement for a TRUSTED processor and system in each of these applications via standards committee with all the requirements as code rules regulation and law. As stated above the effort has been made to get technical collaboration for this direction and good prospects and profit for all have been a major consideration in the planning.

Basic Process

FACT event recordings have a permanent record until the unit is retired in an investigation and or replaced either entirely or in the secured memory portion by authorized personnel (a special service procedure documented for the law-enforcement spider eyes program exists in earlier related filings and in 10/975,109).

The local PFN/TRAC processors and data storage receptacles offer a means via a trusted secure accounting process to make acceptable use of remote or shared equipment controls through responsible and discrete data acquisition not normally tolerated in a free society, but most necessary when joint responsibility and liability questions exist. Once again these characteristic are stressed because some of the basic needs in financial transactions are accurate records, identification and accountability for an action. The use of preprogramming and secure remote connections in the ATMS make them ideal candidates for PFN upgrades, so all machines and equipment around them in a smart PFN cell can report on an ATM operational alert to the proper authorities. This kind of PFN smart security cell can help identify a thief using someone else's identity (detailed in part as The Spider “Eyes Program” with Law Enforcement in 10/975,109).

Process Development

Identifiable data packets (wireless/IP/encrypted) generated throughout routing process/program in a TRAC unit are held in local memory buffers and each buffer of every server in a FACT network for a time (to be determined by network engineers and per legal codes rules regulations or law). Standard processing and packet tracking for completed messages (IP) will be employed with the exception of data storage of transparent messaging being securely stored at all levels until authorized FACT termination of data directives have been received to clear buffers (this process is further discussed in related filings 10/975,109). A secondary backup processing program at the appropriate application level to recover data will do a near real-time integrity check on data received via other dispersed communications connected. This is to be engineered to be a very robust process for confirmation and authentication. All this PFN/TRAC/FACT programming is subject to the application and amendable. Because the electronic payment industry has developed a set of existing stands and practices for authentication in its various technologies software packages, primary authentication and operational processing will take place or be governed by the device and any input firmware initially, A second modality will be application specific programming in the CPU with drivers for the input device, along with a translation software algorithm, and a third possibility is for the data to be downloaded from a remote system or forth a communication processing completed with the remote server. Any and all processing is achievable via the TRAC and will be governed by the individual payment technologies general application of software. Chipset or hardware related firmware can be entered in SUC System Under Control via the plug and play hybrid substrate I/O PFN/TRAC local ASIC detailed in FIG. 3 and all the prior related patents and protected filings.

The PFN communication translator relay station for local First Responders radio synergy is structured from the last two modalities, The plug and play chipsets with transceiver, and digital protocols in firmware or they are downloaded to the PFN CPU via the multiple wireless technologies and universal antenna array already interfaced and converted to any new application capacity needed in the field without contact. Piggy back PS1 s translator repeaters mentioned earlier connect directly to each radio Unit and provide the conversion of another systems signal to and through the antenna because it has the other systems transceiver chipset and an antenna converter. These can be used with or without a PFN to increase PFN capabilities as another I/O modality or to receive more locally PFN process and routed signals or for direct radio to radio local communications. It is anticipated that if all modalities are present n an event area individual switch per radio unit will determine the optimum mode for the desired type of communications and procedures and protocols will be developed via the manufacturers, agencies FCC,DHS, FEMA, DOD and Local Fire, EMS, and Law Enforcement, etc.

Wireless Remote Control Capabilities

All real-time remote control wireless communications are dedicated and real-time sensitive by the synchronized clocking locally and systemically (GPS across the nation and around the world- probably). There is a number of developed algorithms and software technologies being developed for this function and will be needed in TRAC Robotics and Remote Control processing of programs to determine the exact position in space and time of a vehicle connected PFN/TRAC unit with respect to another known PFN/TRAC unit vehicle for example. Other reporting object's physics/velocity and telemetry in general will be carried on real-time dedicated communications for local robust remote control and robotics. These functions are to be monitored and managed and governed by real-time assessment programming augmented by OEM (Collision avoidance programs etc) and default to these operational backups or PFN/TRAC system sensing of the TRAC technology in safe operation modes with reports and records kept in event memory insignificant memory will be erased(via determined application specific protocols. These control models are to be used together with local human control to assist in the safest operation equipment control (The exact relationship and programming to be determined specific to application and any specific event with automated responses determined by those skilled in the art of safe equipment operations in each of the respective fields).

Processing Confirmation for Accountability

Interim progress of the sequence, activity or routing function may be optionally transmitted back to the remote management system through a 2-way phone, wireless, RF, or paging technologies etc. This may occur as the function is executing or may be programmed to occur after completion of the sequence, with accumulated data.

In the case of billing for service or product (data routing) will be stored locally in some cases and downloaded to wireless mass data billing centers in off hours depending on communications traffic. Or may be transmitted in real-time command string in the headers of the data packets, and directed for operational billing programs running in the commercial service provider's computer network Mass data servers. Additionally, these practices may change and will be determined by providers and their business requirements and protocols and any standards efforts rules regulations or law. In any event, local, redundant storage of both types of events is always contained within the PFN for subsequent or simultaneous retrieval of event information and proof for accountability purposes. The PFN enclosure and TRAC monitoring with tamper sensors guarantee the information has not been compromised and can be TRUSTED. These physical protections and electronic protections are detailed in related PFN[TRAC filings(10/975,109). Other types of information include System Function Data (SFD file), which may be stored in the TRAC local event memory for analytical or investigation recoveries.

Other Data may include digital or analog data not directly related to a function being monitored and executed by a host machine. Information gathered via authorized sensing technologies or accessories interfaced with a PFN/TRAC unit will include the wireless interfacing and repeating of HS1 sensor data. And, when recovered the PFN will add time date and geographic position to the data packet recoded locally and reported as a FACT file automatically to the FACT intranet upon the reception from the HS1 . HS1 sensors are Homeland Security PS1 and given this different specification to indicate a public safety or national security directed application. While all sensing can be used for these reasons through the TRAC with the FACT security program HS1 stand alone sensors are specifically planned for this use

Additionally, the reporting and recordings may be for the purposes of evaluating and determining legal liability or be a useful tool for the collection of evidence, or to recover impact data on the environment by the machine hosting the PFN TRAC unit. The public and their legislators will determine what, how and when data can be recovered stored and used: The industry standards efforts and government agencies will adopt public policy and develop, standards, code rules and regulations and law from the data and information. And someday the automotive manufacturers will pay for a license for infringing on this technology and bring their little recording circuit up to PFN/TRAC technology standards for shared control scenarios.

System analysts, integrators, component engineers, programmers and code writers will continually configure the hardware and software to construct the best PFN/TRAC unit and PS1 architecture, to meet public needs and desires. And the courts, justice department and law enforcement, treasury, Federal Trade Commission specific to this application (e.g. Banking Industry's electronic payment industry and First Responder communication) will professionally police operations to insure the will and safety as well as the economic needs of the people are maintained in the implementation of this TRAC and the implementation of FACT Security procedures and program.

Public Monitoring

Examples of public monitoring include road conditions via surveillance audio and/or video, bio and chemical toxins, explosive detection and radiation etc and not just on the nations highways but in every aspect of life that there is movement (Transportation), and or transactions such as money movement or the value of money electronically transferred. All of which can be supported via interfaces with the PFN/TRAC unit and PFN protective structure for data processing and recovery. The use and application still has to be prescribed as stated in the above process. This critical point is a most important embodiment of the technology. This security and integrity capability of the unit and whole of the PFN/TRAC system to detect tampering and access and determine the impacts of equipment actions and human use of equipment can serve to make perpetrators and misuse of the technology accountable.

Additionally, the invention and other technologies impacts on society and societies infrastructures as well as, the world's environment and resources can equally be evaluated. Any injurious practices can be stopped or augmented in programming downloads in near real-time to keep the unit and system current with threats and public policy. To complete this task monitoring and management operation must be broad and professionally accomplished with the proper respect for privacy and personal injury. This cannot be over stated if this technology is to find use in a free society like the United States and should be applied and understood by all the stakeholders and areas of interests. This is why it is threaded into the inventions specification' and technical fabric. Part of the technology of any invention is the technique of operation and what to expect from that operation. Most invention specifications are far to irresponsible in this regard (E.g. the cloning process) Data handling and storage:

Special standards efforts involving those skilled in the legal arts and constitutional law to frame issues for public deliberation on personal and statistical data acquisition, handling and storage is intricate to the invention and (La Technique). As mentioned earlier, to be trusted and accepted by society, The TRAC has to be subject to review from it's inception and continually while in use by all it's stakeholders. To include any process used to handle and store sensitive data for legal use. E.g. The legal discovery process and procedures to insure evidence is properly acquired and not compromise and kept pristine until court convenes and provided equally to the appropriate parties.

DATA Issue: Different Handling of Statistical Data and Personal or Private Data Handling.

Statistical data recovered without personal identifiers being used by the public for better public management. E.g. a 1P PFN/TRAC unit, might well be a personally worn device performing biometrics tracking and telemetry. It is reporting on an individual's heart rate at the top of a long subway stair well via it's DSRC signal as the wearer passes a 1E PFN on an escalator out of service, because a research program is being run on cardiovascular research. This program may also ask for the person's age, sex, race, nationality, any weight data, and any known medical conditions or medications data stored in the 1P PFN memory or limited 1Ps monitor unit. However, no personal identifiers like name, social security numbers health care card or insurance data, address, phone numbers or email can be accessed or delivered. Or shouldn't the wearer be able to select no transmission of data?

At the Very Least:

Shouldn't data recovered be specific to statistical research to better plan a safe and healthier environment and warn citizens at risk of over taxing conditions from a movement task in their environment (like this stair climb vs. an escalator or elevator for those cardiovascular persons compromised. The monitoring is done first to research real-life situations that might be hazardous to ones health and then warn them and others in discrete ways of the danger with general public notices and or through a earpiece attached to the 1P PFN or 1 Ps minimal units and deliver in an audio message to a particular person relevant health and safety data. A similar statistical data recovery for automobile use and highway system evaluation may be used with warnings of dangers in traffic movement. Then a 1E PFN driven sensor might pick up unusually high levels of gamma radiation and quarry all area PFNS and video attached systems with and without other radiation and explosive sensor arrays to sample data and respond.

Employing new technologies like the Noise, an odor detection technology that can detect odors at the molecular level some 2000 times greater than a human's noise. In this latter case the Local FACT event programming is initiated and personal PFNS are quarried to see who is in the area and what does the telemetry and video time synchronized images look like for the flagged radiation event being tracked. Telemetry like: what is the intensity of the radiation and what is the geographic position with audio video data, a list of PFN/ESN and remote control assets, and human intervention assets like police, special first responders, all on one screen with individual screens being specifically monitored by DOT/TSA/HSD/FACT etc. command center or another government agency like the FTC and FBI for their specific purview over bankcard practices and bank fraud. Both of these scenarios are good reasons for acquiring data for public safety, quality of life and national security, but how will it be used and how can we make sure the accountability of the TRAC serves the public good to protect the people and our freedoms and does not invade them or harm us. This is the hard part to get right the human machine and human interfaces of the technology.

Inventor's Suggestion:

Obviously, Civil Liberties should weigh in early and be an on going process through legislation, the implementation phase and inevitably in the court system until we get it right as a society (basically forever or on going business). But this alone does not keep time with the real-time nature of the invention and other IT technologies today. No, the responsibility starts with the inventor to review with as much insight as possible and provide as many questions and routes to answer them as one can see for the technology he/she teaches.

Other groups should be sot out and funded to put a permanent public review process in place to feel the publics pulse and advise law- makers to change the use of the invention as conditions warrant. Groups like The Charles F. Kettering Foundation or The National Issues Forums Institute-NIFIG.Org, with their deliberative process on National Issues.

Another organization is Public Agenda, they to quarry the public to help determine public policy. Additionally, local efforts that seek to gain public opinion in shaping national and community oriented public policy need to be funded and put in place. Programs run by universities and community colleges like Maryland's Montgomery College's “Center for Community Leadership Development and Public Policy with their NIF deliberative Format and other human resource services.

All portions of the public should weigh in together as much as possible on policy implemented. The invention it self can function to quarry the public on issues and even set up issue framing data from logged comments and perform initial survey programs via unit and system programming and people participating in the process. E.g. One issue could be what are acceptable levels of police video monitoring to provide national security? The Reason for this question - Is to determine the correct procedures and protocols for the use of the PFN/TRAC/FACT programming to match the national color codes and how to inform the public of their diminished rights of privacy and how they should be aware of this trade off for increased security efforts. Important to remember is that the use of technologies like the Nose and advanced sensor technologies may take some time to develop the electronic libraries to detect the various bio and chemical hazards, especially in the PS-1 HS1 Homeland Security sensor suites. And when done so only a specific physical configuration of the technology may be used to capture a specific molecular chemistry and that may even have to be sent to a remote processing computer like a PFN/TRAC unit and on in the FACT system to completely identify anything detected out side the known and suspected hazards (Expected and were preprogrammed for).

Implementation

TRAC implementation may be accomplished in many ways, depending on space or funding constraints and level of integration required for the system to control and to route. A PC-based system may be in the form of a desktop system, laptop, palmtop (PDA) Personal Communication unit (PCU) or (PC 104) or embedded system with a dedicated DOS or Windows based TRAC program, consisting of machine language, Basic, C, C++, Visual Basic, Visual C or C++, or other high level language which accomplishes the TRAC function through software control. Interfaces to the System Under Control (SUC) may be accomplished through appropriate I/O cards, either analog or digital, plug and play chipsets with protocols in firmware. Or PC compatible Modems or Cellular phone interfaces (or chipset) provide the interface to the Remote Management System (RMS) and for routing options. SUC and RMS interfaces may be in the form of USB, ISA, PCI, PCMCIA, VME, Compact PCI, Future Buss, or other commercial interfaces compatible with the PC-based system used. More compact and custom implementations of the TRAC may consist of dedicated state machine controller implementations in which TRAC functions are executed through embedded firmware These implementations may incorporate multi-chip (or Hybrid) solutions using EPROM or EEPROM interfaced to Arithmetic Logic Units (ALU), I/O ports and discrete memory elements. They may also be microprocessor or microcomputer based. A large variety of board level products are commercially available for such an implementation. Single chip or high-density implementations might consist of Field Programmable Gate Array (FPGA) or Application Specific Integrated Circuit (ASIC) based devices and Systems On a Chip or SOC technology. Additionally, wireless router functions and signal relaying (digit-peat) might be accomplished with the different wireless protocols in hybrid chipsets with firmware in Plug and play (PC104) interface boards or I/O cards and translation programming and interface developed from developer kits provided from the 18 most frequently used wireless telephony protocols. The same process (developer kits) would be used by the skilled in the art to write code for the universal routing software program (One Possibility is Unix). With this process accomplished for the PFN/TRAC system/FACT Security network to handle EAM messages between protocols it would be termed (TEAM translation software) and provide flexible Translation of Emergency Action Messages (or TEAM messages) for FACT Security.

Universal Communicator Program

One Modality:

This master routing/translation software package would processes same content message material between disparate wireless protocols via a universal library of specific emergency messages and repeat them through out the PFN system as preprogrammed routing dictates for such messaging. These universal messages are to be translated into all known human languages as well. This program is to have a voice recognition algorithm to identify languages spoken and a universal audio and video set of pictures to accompany these TEAM messages that are physically translated by signal.

All TRAC implementations may incorporate all sequencer, firmware, I/O and storage functions on a single device and would provide the highest level of integration with the smallest possible size. The displays, Video and Audio, Auxiliary Data for the TRAC can be constructed of many forms and types. These may range from analog systems, in which tape or other magnetic media store the analog signal, to semi conductor or digitally burned systems in which data is stored on hard disks, EEPROM or RAM. Data format may be modulated through FM or AM, compressed and packeted or otherwise encoded for reduced bandwidth or for transmission over the Internet to include (IP packet audio and video).

The vast amount of possibilities and form for the TRAC are deliberately designed for the PFN interfaces to be application flexible with a continual effort to be as inclusive as possible of all technologies to provide versatility and universal connectivity for the public and the free market system.

Varying degrees of size and sophistication in the various PFNS and 1Ps or PS-1 HS1 sensing platforms will exist at any given point in time and this is meant to provide an inclusive system that takes advantage of all the technology past, present and future. There will be Complete PFN/TRAC units with multiple wireless interfaces and routing (Universal-PFNS) to include long distant communications that will be smaller in size than the more simpler PS-1 HS1 wireless sensor platforms that sends signal to the regular PFN/TRAC units. Complete secure accountable connectivity for human and machine messaging is the goal of the PFN/TRAC System and Federal Access Control Technology to improve public safety and national security.

Hardware Implementation are to be Progressive and Flexible

Trusted Remote Activity Controller (Generally) will be COTS Based PC-Programmable Controller (PC104)-Custom Logic Sequencer μP (Micro processor) FPGA (Field Programmable Gate Array) Custom Gate Array with ASICS progressing to include Systems On a Chip or (SOC) technology, ultimately constructed with room temperature super conductors (plastic) for greater computing speeds and less current demands.

It is because of this capacity for growth and accommodation of existing COTS and legacy technology (hardware, firmware and software), that software functions are not specific in programming or detail. The chosen teaching technique for the implementation and processing throughout developing the diverse PFN/TRAC architecture is to explain how to construct the invention the PFN/TRAC movement management system with FACT security program and a communication routing process, so that those of normal skill (artisans in the specific disciplines can workup the many thousand final configurations, construct and program the PFN/TRAC controller/router and network to the desires of the stakeholders (the public, industry and government) and continue to reduce in size and expand in capability the 2 device platforms the PFN and PS1 until they are one and can even serve as the mass data system. The laborious work of the programmer and code writer for the specific existing hardware configurations will be a massive but hopefully a shrinking challenge as platform architectures technically become more standardized through out the different industry applications. This is demonstrated in the many prior related teachings for the separate industries to be PFN/TRAC linked.

TRAC Features

Industry Accepted and Trusted System
Uses “Industry Standard” Interfaces
Provides Accountability Requirements
Aggressive Remote Control Functions,
It is Programmable & Modular,
Scaleable
Provides Levels of Redundancy,
Event Storage,
Algorithm Type is Dependent on Application Accountability Requirements,
Resides in PFN (PFN Provides Physical Security)
Remote Management Command Authentication,
Electronic Payment Industry
Local System Control and Event Storage, Software/Algorithms Bank/Stock Exchange
Transaction Products & Algorithms
RPV (Remotely Piloted Vehicle) Technology,
   Security, Commercial: 128/64 bit Encryption PGP (Web Transactions), Military: DES (Data Encryption Standard) & all the FACT Program functions programmed in the different software protocols to operate on local hardware in the PFN/TRAC system architecture
Interfaces
Electronic Payment industry
Automotive Industry Standardization Efforts,
IEEE Standardization efforts,
Avionics Standardizations efforts,
Rail Standardization efforts,
Marine standardization efforts,
Electronics Standardizations Efforts,
Computer Standardizations Efforts,
H-Rel Connectors,
Actuators,
Sensors,
Signal Levels
Wireless Telephony and data interfaces
Digital Cellular, PCS,
56K Modem, Faster
RF & Pager Technology,
All the approved aviation wireless technologies,
All marine,
Interactive Highways
All DSRC,
All emergency frequencies
AIP Airline Control Protocol,
First Responder links to TSA n air ports

Program considerations for wireless routing in air travel industry for HS1 data packets. Data link layer polled protocol that runs in full-duplex mode over synchronous serial (V.24) lines and uses the binary-coded decimal (BCD) character set, Airline Product Set ALPS circuit, And a communication path across a TCP connection between a host reservation system and an ASCU. When MATIP encapsulation is used on an ALPS circuit, it is equivalent to a MATIP session., ALPS Tunneling Protocol airline protocol, Generic term that refers to the airline reservation system data and the protocols, such as P1024B (ALC), P1024C (UTS), and MATIP, that transport the data between the mainframe and the ASCUs., Airline X.25
Dynamic Host Configuration Protocol (DHCP), [RFC-2131], a framework for passing configuration information to hosts on a TCP/IP network
Time of Day Protocol [RFC-868], to obtain the time of day
Data or network
Edge or access router
DSP medium
RF medium (coax, modulator/demodulator, antenna)
RF management software
   Wireless Standards Effort

PFN/TRAC units will provide a less expensive, more comprehensive, secure and stable mobile platform for the development of wireless routing and interfacing with equipment, via the portable WLAN network created. The system is to start Internet data packet routing at the earliest point data is generated and apply this technology universally across the wireless spectrum. The system will always remain diverse and need planning to insure enough of the properly programmed PFNS or more universal PFN units are present for adequate coverage of all types of wireless and to maximize the recovery of HS1 data. Immediately by the introduction and explanation of the unique messaging in the air travel/transport industry the reader and skilled in the art of network design and engineering can rapidly see the need for the more sophisticated universal PFNS to translate and repeat to bridge the gap for inter-model transportation and machine messaging between the different vehicle platforms and industries that will handle the same PS1 HS-1 equipped packages or containers or RFID and Bar code package markings.

The process will always be an evolving one of forward and backward engineering as well. However, the flexible interfacing via Plug, play and program architecture at local routing interface (proprietary to the PFN/TRAC system) will aid immensely in this process. With more dispersed ownership and maintenance to include the individual public to lower industry cost, the PFN/TRAC System and machine messaging system for the United States can automate all machine and equipment controls in an inexpensive manner. As standards emerge and technologies merge the specific technology will be refined and miniaturized into SOC configurations.

There is always to be a flexible plug, play and program interface capacity to grow and keep current with new technology and accommodate legacy technologies in the PFN/TRAC System and FACT security network. The FACT network via it's industry specific registries must be programmed and agency staffed and capable to recognize all new interfacing and system augmentation and provide a review process and integrity check; both at the local interface PFN/TRAC unit and system wide levels to check for alerts or anomalies. Either because of FACT programming, or to write code to flag events as FACT alerts and upload any critical data to all effected PFN/FTRAC units for the most real-time preprogrammed responsiveness.

At least 18 different types of wireless are in commercial use today. Therefore, as PFN/TRAC technology becomes more prevalent, many of the applications will migrate to specific architectures and product interfaces. The different types of wireless are quite unique to each other in numerous respects, and require specific types of expertise to deploy, use, and maintain them.

A Look at the Wireless Advantage For Change.

The pros include:
It's much less expensive to deploy than hardwiring.
It's much quicker to deploy—.
Wireless can go in inaccessible terrain.
It involves an inherent high degree of security, and additional security layers can be added.
Wireless provides broadband mobility,

PFN/TRAC wireless link will be a fully featured router, which means that it must provide VPN, enterprise toll bypass, and MDU/MTU access services where these are not present by commercial providers and or be interfaced into local PFN/TRAC units to include with the cross protocol translation programming and routing. These PFNs will retrieve the HS1 sensor array data as a wireless gateway and deliver data to the various IP addresses. The fundamental elements remain relatively constant between the wireless providers allowing PFN/TRAC router access to translate between the protocols retrievable at Layer 2 of the wireless protocol stack for the most part with the data packets and universally synced timing. The majority of wireless vendors access the wireless stack at layer 2 and some at Layer 3 like Cisco Systems routing for cable routing. Depending on application any specific PFN/TRAC unit would have programming at least for one maybe both accesses layers to the TRA/FACT stack with unix programming at a higher application level to perform the translation algorithmic functions where packet transfer was not possible. And through out any specific TSA/FACT intranet (e.g. FACT/TSA airport terminal a PFN/TRAC unit in the matrix would have the capacity both to access long distant communication links both wired and wireless and digi-peat packet messaging from the HS1 to the appropriate IP addresses for TSA/FACT Homeland security.

A Data Handling Modality Example for Wireless PFN Machine Message Programming

The protocol stack implemented for TRAC/FACT could be based on the DOC SIS standards developed by the Cable Labs consortium. The principal function of the wireless portions of the TRAC unit is to transmit Internet Protocol (IP) packets transparently between TRAC controller/routers in the FACT security control matrix via direct dial ups or through wireless gateways in the FACT and commercial TRAC intranets with ISP and broad band high speed connections. Ideally, certain management functions will be impregnated via IP to include spectrum management functions (for identification, addressing, wireless accounting purposes and software downloading). Both ends of any wireless link are to be IP hosts on the network matrix, and they fully support standard IP and Logical Link Control (LLC) protocols, as defined by the IEEE 802 LAN/MAN Standards Committee standards wherever appropriate (for wireless telephony the HS1 system interfaced via PFN/TRAC units and PFN/TRAC system terminals). The commercial servers generally support the IP and Address Resolution Protocol (ARP) protocols over DIX and SNAP link layer framing.

The primary function of the wireless system is to forward packets. As such, data forwarding through the commercial servers is done with transparent bridging or network layer forwarding such as routing and IP switching. Data forwarding through the PFN/TRAC system could be accomplished with link layer transparent bridging based on IP protocols. Forwarding could be similar to [ISO/IEC10038] as per any applicable DOCSIS specifications. Both ends should then support any spanning-tree protocols to include capability to filter 802.1d bridge PDUs (BPDUs) with out loops in specific intranets and support for Internet Group Management Protocol (IGMP) multicasting. FACT and special encryption applications would be above the network layer, This transparent IP capability will be bearer for higher-layer services. Additional translation programming between protocols should run at these higher levels. Use of these services will be transparent at the unit level unless the unit is running these higher program applications by authorization and identification (e.g. DES or special TSA Homeland security programs setup as PFN/TRAC (Possibly DET) terminals or protected and secure at the same level. In addition to the transport of user data, several network management and operation capabilities are supported at both ends of any intended messaging, to the PFN/TRAC unit platform.

The Primary Focal Node access wireless architecture as a router allows it to serve as a hub or mini relay station serving other nodes (PFN/TRAC units and the many PS-1 HS1 sensor platforms in a WLAN portable network). In the above described application. It is a point-to-multipoint architecture in the sense that the entire bandwidth on the upstream and downstream is shared among all the responsive PFN/TRAC units to the individual HS1 sensor suite if desired. The protocol stack implemented to make all this work is based on the DOCSIS standards developed by the Cable Labs consortium.

This is but one proposed modality of routing via the PFN/TRAC controller/router to construct the flexible web with current hardware and software available and the PS1 HS1 sensor platforms proposed to meet today's Homeland security threats from toxic chemicals, biohazards and nuclear waste.

PFN/TRAC unit characteristics in FACT TSA air travel network as an example

They have local event memory storage in protected containments;
Report to mass data management and storage centers at the airport;
They can have wireless and wired connections to sensors and sensor platforms; and,
Multiple communication technologies and protocols;

They have automated radio frequency scanning and translation between different wireless protocols.

In addition, PFNs have back up power supplies;
They provide the means to add electrical functions to legacy equipment; Interface separate equipment and existing security systems into one management system; Respond locally and to repeat messages and signals to and from each other as well as,
To other remote portions of a monitoring system;
They provide their physical location (GPS or recoded fixed address) with the data
They report; and can drive audio and video equipment and other data recovery devices; They can operate automated robust actuators and equipment controls;
They perform real-time remote control with accountability;
They perform their own integrity checks and of assets interfaced and inventory with them;
They can perform self-maintenance checks and diagnostics; and affect repairs automatically and remotely;
They can detect tampering; and operate with encrypted programming PGP and DES; as well as, complete operations independently preprogrammed and robotics functions;
They can operate electronic payment industry programs and ID programs; and drive Card swipes; Explosive Detection Equipment, and all sorts of transducers, sensor arrays;
PFN/TRAC router functions

Network data flow to the remote management system and provide local robust broad spectrum data and communications routing

Elements of a Total Management and Security Network Solution For Transportation or Movement of Anything:

Premises Networks

(PFN portable network) e.g airports, ports, rail terminals, Installations, boarders, stores flooded cities, cities under attack etc.
   Access Networks
   E.g. Primary Intranet FACT/FAA/TSA Terminal Command Center and National Air Travel
Core networks DOT/FACT/TSA National Mass Data handling and storage matrix of intranets for air, land, sea, boarder customs, national security agencies home land security
Network management PFN/TRAC System and FACT program
Billing/OSS PFN/TRAC system, electronic payment industry, etc.

A fully comprehensive wireless solution must also include the issues of deployment, maintenance, legacy, migration, and value propositions. The scope of what comprises a fully comprehensive solution is addressed throughout this filing and the related filings.

FIG. 5

Returning to the automated store building or business FIG. 5 shows an innovative example and the extent of this universal electronic payment capacity: A disinfectant flushable towel wipe dispenser in restrooms is responsive to all kinds of electronic payment, with a flat stack and two enhanced versions, automated and motorized stop.

Exemplary Product to be Dispensed

The original design on the left is designed with a fold to pull the towelete out of a vertical slot. The towelete in the feasibility prototype will be 5″ wide by 8 “long with the pocket 5 to 6 ½”. Final engineering and product analysis will be used to fine tune the product for the greatest commercialization. This includes the initial design and any number of product variations of the towelete and pocket. The basic towelete dispenser in this figure is numbered 500. This unit has two access panel locks numbered 501. 502 is the center slot for the toweletes to be pulled through. The locks can be reduced to one lock in the middle. These pre-moistened towels would be in a plastic bag and flat stacked or could be folded for sequential dispensing. 503 is the pull fold and 504 is the towelete pocket. This dispenser can be mounted in the same manner as described for the other dispensers.

Automation mechanics for electronic payment interface of this product. (total automation covered in Patent 300 and 10/975,109 for the interface of the electronic payment industry to all machines, vehicles, equipment.

On the Right side of FIG. 5 there are two types of automated dispensers 500M and 300M. The top 500M is the original 500 dispenser to the left with an automated door 508 that is drawn back by a spring loaded connecting shaft 511 and activated by a solenoid 512 to open the towelete dispensing port 502. 506 is the power source and 505 the infrared sensor switch for courtesy dispensing. The change box 510 is inserted into the sensor/switch circuit with 510 connection to complete the circuit when the appropriate coin is placed into 509 slot. The coin counting box 507 would be connected into sensor/switch 505 circuit for the automated models 305M and 500M dispensers. The 305M motorized version of the manual roll dispenser is shown on the right top side of FIG. 5. 506 is the power source, 505 the sensor/switch circuit, 513 the drive belt from dispenser motor 514 with 515 a micro controller that is preprogrammed with firmware (software imbedded hardware) for the correct amount of micro seconds to dispense the roll type Lift-ups or activate the solenoid door for the 500m flat stack dispenser to allow for the removal of a towelete mitten. Or, the 515 micro processor can be housed in the 507 change box, or in the 606 PS1 universal electronic wireless credit technologies sensing block, and send the appropriate signal to dispense product (singular or multiple) via the appropriate machine language (analog or digital) to complete a dispensing cycle as well as, read and report the data from the electronic medium being used.

The two versions to the right in FIG. 5 are automated dispensers and are designed to teach and demonstrate simple functions of another proprietary technology called the PFN/TRAC System. This mechanism employs wireless electronics and requires additional licensing from Kline & Walker LLC and or TRAC Aviation Inc before commercialization. Theses models and technologies will be depicted in this application but are detailed further in related PFN/TRAC/FACT applications. These patents and pending technologies teach the universal employment of electronic payment technology both existing and future Commercial Off the Shelf Technologies or COTS such as; RFID, Smart Cards, Magnetic Strip Credit Cards, Easy Pass, Mobile Pass, Wireless phone accounts and biometrics to include eye scan, face scan, finger/palm scans, and DNA recognition as well. Additionally taught are proprietary identification technologies including additional biometrics and micro-chip implants that are supported through the wireless platforms; PS1, HS1, 1PS all stand alone self powered units with dedicated short range communications or DSRC links, to equipment PFNs and Vehicle powered Primary Focal Nodes or PFN relay stations that are also equipment and vehicle controllers known as trusted remote activity controllers or TRAC processors. In this application the technology is applied to commercialize Restroom “Purity Products” and enhance this simple invention, The Lift-Ups towelete dispenser. As time goes on these electronic payment tools will replace pocket change for automated vending.

FIG. 6

As stated in five this figure is provided in this specification teaching another innovation that utilizes the electronic payment industry to enhance the commercialization of this product and to maintenance and sell other paper goods. As stated earlier it is protected technology of Kline & Walker LLC., and provides wireless sensing and reading platforms, the PS1 (Self powered) transceiver to the PFN (Primary Focal Node) for traditional electronic credit and debit transactions to be read and relayed through a chain of wireless and regular data links in real-time rather than using change to operate automatic vending machines. FIG. 6 includes future personal biometric identifications as inherent electronic payment technology, and this technology is taught in 11 PFN/TRAC System patents for wireless messaging and remote control. As part of the electronic payment industries the PS1 Universal electronic payment block and Primary Focal Node PFN receive direct Bluetooth and 802.11 wireless phone transmissions and allow for an individual to charge these services to their cellular phone account as this service becomes more available in the US. These technologies are owned by Kline and Walker LLC and require additional licensing for individual vending applications. They are introduced here only as an option for product and equipment manufacturers, building maintenance companies and retail merchant operations that are interested in a cost effective way to introduce new products, order and stock machinery and account for inventory and all transactions without dealing with cash and questionable people (customers and Staff). In other words other than product stockers there is no need for any attending staff. Any and all products using electrical vending equipment can be automated for the sale of product via the electronic payment industry with less cost and greater financial security for all.

FIG. 6 shows all the different electronic payment technologies that can be used to purchase the lift-up invention as well as, other bathroom products in this case called “Purity Products™” through the center 606 unit, which is the PS1 to PFN Primary Focal Node system invented by Richard Walker one of the inventors in this application. This universal wireless electronic payment system has many equipment dispenser applications and requires additional licensing for its application with this invention, and or any other vending applications. Obviously, there will be a growing portion of the population that will insist on public restroom owners providing Lift-ups to clean soiled seats. There may even be health regulations requiring them. But still many restroom owners are not going to like incurring additional cost to supply these extra paper products. In FIG. 5 the electronic 507 coin counter is one solution allowing the store owner to collect change from those that are willing to buy the lift ups. And even a coin box with the honor system might help defray this cost of new product growth. However, public restrooms are notorious for the less than honorable, who perform dubious acts of theft and vandalism. Meaning that any change box connected to a dispenser adhered to the stall wall is susceptible to theft or destruction.

This makes the electronic purity pass system an ideal remedy to control the dispensing of unattended products keeping a real-time inventory and collecting revenue. 606 a PS1 invention has a card slot 608 for magnetic strip cards (Credit and Debit), a secure connector 607 to a micro processor, 613 that has input interfaced from the card swipe 608 and 605 sensor/scanner for smart cards and RFID, easy pass and mobile pass as well as a Bluetooth or 802.11 or any other comparable DSRC transceiver for 614 cellular accounts and to connect with 609 or 609PFN at the store register or operational computer. 605 sensor scanner has an infrared sensor to detect body heat and dispense the product as a courtesy with no charge if so desired. 605B can receive signal at the vending application or be embedded in the equipment PFN leve at the store register or building computer as show is FIG. 6 with the cellular device making connection to make store purchases from both the PFN register and 606 universal payment block. 605B is for biometric sensing of eye iris, finger & palm print, face points or any other defining part of the body and DNA identification as applied to the electronic payment industry and security applications 607 connecter is shown as connecting pins on the side of the PS1 electronic payment technology sensor array for easy understanding however, this would be on the back of the 606 block and secured directly to 500M or 300M dispensers in FIG. 5 with a hardened connection and mount to thwart tampering. The circuit would have tamper detection firmware preprogrammed into 613 the microprocessor, that would use the dedicated short range technology either DSRC FM or Bluetooth or 802.11 standard to the store computer. Obviously, this is overkill for a simple bathroom application for this invention Lift-ups, but starts to make sense to major paper product manufacturers, hotels and office buildings that would like to save cost in maintaining clean well stocked facilities and selling those products via electronic ordering and payment. And other applications such as vending machines in automated cafeterias and food services or highway rest stations to offer a lot more unattended services with out having to worry about cash transactions and the risk of violent thefts. Even attended operations can employ the universal electronic payment node and completely eliminate the threat of theft.

Looking to the left side of FIG. 6 the “Buy” column area the viewer can see the basic payment modalities that exist today and those that will be available in the future. Starting from the top is the standard credit card with a magnetic strip shown as a combination of 601 & 603. A combination of 601 and 602 is a smart card with a chip processor that can be configured with hard contact points to deliver data to the 606 block through a mating slot or as an RFID technology to a sensing antennae as part of the 605 sensing array. 604 would use RFID or small transmitter unit like a Mobile pass or Easy pass and the 605 sensor array/antennae/receiver would deliver the electronic payment data via industry standards of 128/256 encryption to the store computer, smart register or PFN connected register for local record keeping and accounting (Returns Column) and through the electronic payment industry 610to the credit card computers via 611 data link (regular IP connections and telephone / fiber optics/cable) to 612 the product manufacture computers. The payment process can be credit or debit where customers buy credit ahead of time on their electronic payment device accounts, or for their own biological identity account 605B Biometric ID system, or assed against their 614 cellular telephone account, or through normal credit purchases and they pay their monthly bill for their use of products and purchases. Depending on the software programming requirements either the PS1 606 universal wireless sensing/reader block for electronic payment devices can process the relevant data locally via burned in firmware or it can transmit the data compressed and encrypted once read to the store computer PFN register transceiver interface or smart register where more extensive programming can be handled, to include secure processing via the Primary Focal Node/Trusted Remote Control relay station, or PFN/TRAC System.

FIG. 7

These 1PI PFN-PFN Implants and 1Plsb- Soma Battery PFNs which uses a person's body as the power source are subcutaneous inserted and or injected under the skin or into soft non vital adipose or fatty areas of a person's or animals body. They are a miniaturization of the 1 P Personal PFN circuit that is first miniaturized from COTS products on a belt to a smaller version placed on a belt, band, bracelet and or woven into garments and then reduced in size further to a SOC micro chip circuit for implantation in to living animals. The encasement is made of high quality surgical stainless steel or noble metals or coated by them that are known to be non allergenic and safe for internal use in the body. The chassis ground current will be contact with the conductive noble metal which in turn is in contact with allow the body's internal moist conductivity properties to enhance the minimal signal and patch antenna. Then a personal carrier of a 1PI & 1Plsb can just touch the chassis of another host machine or PFN to complete a ground side connection and deliver data in the PFN/TRAC System matrix with the most minimal current levels(ID and GPS data)(person and last known location).

These 1PI and 1Plsb PFN versions first and foremost have a DSRC dedicated short range communication wireless connection that can normally transmit hundreds of feet or up to a mile effectively to deliver a EAM (emergency action message) to all other 1E-1SV and 1A PFN and equipment PFNs in the PFN/TRAC machine messaging matrix and FACT security and registry data bases. At this point local first responders are to be notified immediately with the IP notification of all relevant agencies and FACT registry data bases (e.g. Local police and regional and national FBI computer networks for a lost child or person scenario as well as directions and info uploaded to any local amber alert system or intelligent highway system, public media, civil alert system and web page alert. Special security applications include military, police, fireman, mental and medically at risk persons. (eg. For military—these 1PI family of PFNs and their EAMs may be used to identify friendlies and combatants and release or with hold for use a remote controlled military asset on a battle field or base) or used to locate a lost person or one requiring medical assistance or even provide that medical assistance from a remote location via automated medicators also inserted in the body and interfaced)

Body Function Remote Control and Robotics (Cybernetics)

The PFN/TRAC unit is to give mindless machines a Brain or artificial intelligence and also to share activity controls in an accountable manner with humans for equipment to assist them when unsafe operation is transpiring. Why then should it stop there? Why not have this remarkable movement management system help those who do not have control over their motor functions to move as the desire. (e.g. the paraplegic and quadriplegic) (this portion defers to the prior healthcare and conditionally released PFN/TRAC telemetry and remote and automated control technology filed earlier) 1PI PFN unit sets would be constructed as a harmonious set of dispersed of SOC circuits interoperating by wireless and gaining their power from pacemaker type batteries or other power source technologies. Then they can be used to deliver a measured electrical charge to nerve bundles to stimulate a radiating synaptic response and cause a proportional tetanus in the muscle for controlled contractions by recognizing the amount of muscle contraction. (cybernetic robotics via local RC from the set of 1PI PFN/TRAC components. Thereby returning controlled movement where nerve function is absent. Via additional connected or wireless inter-muscular sensor implants sending a digital signal for processing by the local TRAC processor 1PI implant running a special individual movement algorithm, initiated and managed by the patient learning how to control bio-feed back tones for the desired muscle activity(to stretch and twist/turn walk and run. Also an audio implant for bio feed back would be implanted in the auditory canal or a hearing aid style of receiver outfitted. Also, muscle fatigue sensors for lactic acid build up are required. So sensors also implanted into muscle bundles to detect the PH would be done by injection or surgery. Then this conductivity change world provide a digital tone to the individual so that when the muscle was fatigued prior to cramp or damaging spasm. This change in conductance would be monitored and if the transfer of the potential energy between any over worked muscle and other portion of the body could result in the generation and storage of electricity in the PFN power supplies via the contrasting electrode innovation discussed above a charging circuit would be real-time constructed by energizing it via the monitoring program in the TRAC processor (or power supply firmware). This could also rapidly dissipate the toxic PH levels for the effected muscle group as well.

The only problem with these cybernetic is that the implanted individual would have to wear aluminum foil close for when they are driving a car through a radar trap or they might leap though the roof of the car by false activations just kidding, but the system would have to be well engineered to reduce the chance of casual environmental RF noise EMF and EMW affecting the system These application specific to the Air travel air transport industry, might apply for any of the conditionally released or physically and or mentally compromised. As a condition of transport of dangerous criminals injected motor controls over the physical actions by remote control may prove necessary. A hostile act detector may be constructed and might read adrenalin levels and other biometrics and restrict muscle movement via antagonist muscle stimulation to a detected aggressive blow for example. Obviously there is a number scenario that need the public to deliberate on and the inventor has stressed this already. But the possibilities are endless in controlling human activities and body functions, as well as machines. This is also why the innovations are divided application specific; to keep the stakeholders and public voices appropriately a lined to develop a reasonable good and free movement management system with security. And not just a monopolize and dominate with a master control technology that could be improperly applied by the few. That is not and cannot be a TRUSTD technology Commercial dispersion of the technology into the specific government and industries companies is a necessary element and so is a coordinated collaboration in system integration so they have to have a relationship to do business. Special structured Joint venture agreements and licensing will be in place to try to insure this diverse property of the technology. (Total Accountability all the time must be there)

FIG. 8

intro:

Public safety officials generally recognize that effective “interoperable” communications is the ability to talk with whom they want, when they want, when authorized, but not the ability to talk with everyone all of the time. The effective interoperability of wireless systems permits a rapid and coordinated response to an emergency incident, whether that incident is a “routine” spill from an overturned tanker truck or railcar, a natural disaster, or a terrorist attack.
The current wireless interoperable communications capabilities of first responders nationwide has not been determined. The Office of Management and Budget (OMB) has designated the Wireless Public Safety Interoperable Communications Program (SAFECOM), within the Department of Homeland Security (DHS), as the focal point for coordinating federal efforts to improve interoperable communications.
The federal government can provide the leadership, long-term commitment, and focus to help state and local governments meet interoperability goals. For example, the federal government can provide the leadership and support for developing (1) a national database of interoperable communications frequencies, (2) a common nomenclature for those frequencies, (3) a national architecture that identifies communications requirements and technical standards, and (4) statewide interoperable communications plans.
DHS has recently created the Office of Interoperability and Compatibility to coordinate the federal response to the problems of interoperability in several functions, including wireless communications. This office would be the initial governing agency to set up the First Responder radio registries identifying frequency systems and protocols in a responsive data base to provide data uplinks to the satellite shown in FIG. 8. Obviously any number of global communications could be employed. From IMARSAT DOD Military Joint Tactical Communications to SATCOM or all under direct oversight of the governing agency or department.
With input from local governments and first responders, states can serve as focal points for statewide planning to improve interoperable communications. States can play a key role in improving interoperable communications by establishing a management structure that includes local participation and input to analyze and identify interoperability gaps Interoperable communications is not an end in itself. Rather, it is a necessary means for achieving an important goal—the ability to respond effectively to and mitigate incidents that require the coordinated actions of first responders, such as multi-vehicle accidents, natural disasters, or terrorist attacks. Interoperable communications are but one component, although a key one, of an effective incident command planning and operations structure. As shown in FIG. 1, determining the most appropriate means of achieving interoperable communications must flow from a comprehensive incident command and operations plan that includes developing an operational definition of who is in charge for different types of events and what types of information would need to be communicated (voice, data, or both) to whom under what circumstances.

Other steps include:
defining the range of interoperable communications capabilities needed for specific types of events;
assessing the current capabilities to meet these communications needs;
identifying the gap between current capabilities and defined requirements;
assessing alternative means of achieving defined interoperable communications requirements; and
developing and implementing a comprehensive plan—including, for example, mutual aid agreements, technology and equipment specifications, and training—for closing the gap between current capabilities and identified requirements.

### BACKGROUND

Interoperable communications requirements are not static, but change over time with changing circumstances (e.g., new threats) and technology (e.g., new equipment) and additional available broadcast spectrum. Consequently, both a short- and long-term “feedback loop” that incorporates regular assessments of current capabilities and needed changes is important.

In addition, the first responder-community is extensive and extremely diverse in size and the types of equipment in their communications systems. According to SAFECOM officials, there are over 2.5 million public safety first responders within more than 50,000 public safety organizations in the United States. Local and state agencies own over 90 percent of the existing public safety communications infrastructure. This intricate public safety communications infrastructure incorporates a wide variety of technologies, equipment types, and spectrum bands.4 in addition to the difficulty that this complex environment poses for federal, state, and local coordination, 85 percent of fire personnel, and nearly as many emergency management technicians, are volunteers with elected leadership. Many of these agencies are small and do not have technical expertise; only the largest of the agencies have engineers and technicians. The above statements, excerpts from a opening statement of the OMB to solve the First Responder interoperability Radio problem clearly show the need for a simplistic cost effective technical solution to provide inclusive radio communications in an instant between disparate communication technologies. As stated earlier the universal PFN router Relay shown here in FIG. 8 in the center of the diagrams receiving download programming for new units entering an event area is one modality and logical device improvement to coordinate communications between these disparate systems and organizations in real-time or near real-time. Also good planning training and in place procedures and protocols that flexibly anticipate the hurdles to achieve completed operations in these emergency scenarios (FACT scenarios) are essential as evident in these OMB statements. They are provided to in the nature and spirit of the invention to address the issues openly and apply the teachings of the PFN/TRAC technology for review, discussion and problem resolution.

OMB

For over 15 years, the federal government has been concerned with public safety spectrum issues, including communications interoperability issues. 5. A variety of federal departments and agencies have been involved in efforts to define the problem and to identify potential solutions, such as DHS, the Department of Justice (DOJ), the Federal Communications Commission (FCC), and the National Telecommunications and Information Administration (NTIA) within the Department of Commerce (DOC), among others. Today, a combination of federal agencies, programs, and associations are involved in coordinating emergency communications. DHS has several agencies and programs involved with addressing first responder interoperable communication barriers, including the SAFECOM program, the Federal Emergency Management Agency (FEMA), and the Office for Domestic Preparedness (ODP). As one of its 24 E-Gov initiatives, OMB in 2001 created SAFECOM to unify the federal government's efforts to help coordinate the work at the federal, state, local, and tribal levels to establish reliable public safety communications and achieve national wireless communications interoperability. The SAFECOM program was brought into DHS in early 2003. In June 2003, SAFECOM partnered with the National Institute of Standards and Technology (NIST) and the National Institute of Justice (NIJ) to hold a summit that brought together over 60 entities involved with communications interoperability policy setting or programs. Several technical factors specifically limit interoperability of public safety wireless communications systems. First, public safety agencies have been assigned frequencies in new bands over time as available frequencies become congested and as new technology made other frequencies available for use. As a result, public safety agencies now operate over multiple frequency bands—operating on these different bands required different radios because technology was not available to include all bands in one radio. Thus, the new bands provided additional capabilities but fragmented the public safety radio frequency spectrum, making communications among different jurisdictions difficult. Another technical factor inhibiting interoperability is the different technologies or different applications of the same technology by manufacturers of public safety radio equipment. One manufacturer may design equipment with proprietary technology that will not work with equipment produced by another manufacturer.

These points are the argument for a cleaner process than that that exist at the FCC today. Commercial buying and selling of the public' airways have left the US with this cheap radio service that is fragmented through product competition. The PFN is a collaborative form of economic expansion allowing for the efficient routing of present day disparate communication technologies, while an expanding economy's profits on the improved service and analytical review of device and systems architecture to guide future inexpensive interoperability development as an ongoing process.

OMB

Technical standards for interoperable communications are still under development. Beginning in 1989, a partnership between industry and the public safety user community developed what is known as Project 25 (P-25) standards. According to the Public Safety Wireless Network (PSWN) 6 program office, Project 25 standards remain the only user defined set of standards in the United States for public safety communications. DHS purchased radios that incorporate the P-25 standards for each of the nation's 28 urban search and rescue teams. PSWN believes P-25 is an important step toward achieving interoperability, but the standards do not mandate interoperability among all manufacturers' systems. Standards development continues today as new technologies emerge that meet changing user needs and new policy requirements.

PFN technology can bridge this gap with the universal local router operating disparate and non conforming P-25 Standards via the 4 described modalities in figures three and four. Conversion in real-time between the radios on P-25 and the disparate units can be processed at different levels or in firmware chips translated and cross coded and redelivered of related in the other frequency and protocol. This still is a band aid approach but a progressive on that achieves the desired result sooner and works out the bugs for future improvements with consolidation in the field with what exists today.

The following OMB and FCC statement show a real effort to provide the future frequencies that have the physic to support the voice and data multy transmission requirements needed to effectively handle and emergency (or FACT Event) and the board band will allow for local remote and distant remote control of equipment interfaced with PFN/TRAC units so the First Response to a dangerous event doesn't have to involve humans in harms way.

Once again Government this time the FCC stresses the need for Local and State Government to be involved in determining need and deficiencies with regard to interoperability at the state and local levels. The following statements highlight the issues that are considerations for the technology to be effective. It is the understanding of these issues final PFN designers and software engineers and code writers must be aware of in their development of standards, codes, procedures and protocol development for the PFN router relay translation station and the PS1 piggy back translator augmentation for interoperability interfacing with the technology.

Page 8 GAO-04-1057T

Third, new public safety mission requirements for video, imaging, and high-speed data transfers, new and highly complex digital communications systems, and the use of commercial wireless systems are potential sources of new interoperability problems. Availability of new spectrum can also encourage the development of new technologies and require further development of technical standards. For example, the FCC recently designated a new band of spectrum, the 4.9 Gigahertz (GHz) band, for use and support of public safety. The FCC provided this additional spectrum to public safety users to support new broadband applications such as high speed digital technologies and wireless local area networks for incident scene management. In providing the additional spectrum, the FCC requested comments on the implementation of technical standards for fixed and mobile operations on the band. The federal government, states, and local governments have important roles to play in assessing interoperability needs, identifying gaps in meeting those needs, and developing comprehensive plans for closing those gaps. The federal government can provide the leadership, long-term commitment, and focus to help state and local governments meet these goals. For example, currently national requirements for interoperable communications are incomplete and no national architecture exists, there is no standard database to coordinate frequencies, and no common nomenclature or terminology exists for interoperability channels. States alone cannot develop the requirements or a national architecture, compile the nationwide frequency database, or develop a common nationwide nomenclature. Moreover, the federal government alone can allocate communications spectrum for public safety use. One key barrier to the development of a national interoperability strategy has been the lack of a statement of national mission requirements for public safety—what set of communications capabilities should be built or acquired—and a strategy to get there. A key initiative in the SAFECOM program plan for the year 2005 is to complete a comprehensive Public Safety Statement of Requirements. The Statement is to provide functional requirements that define how, when, and where public safety practitioners communicate. On Apr. 26, 2004, DHS announced the release of the first comprehensive Statement of Requirements defining future communication requirements and outlining future technology needed to meet these requirements. According to DHS, the Statement provides a shared vision and an architectural framework for future interoperable public safety communications. DHS describes the Statement of Requirements as a living

Federal Leadership Could Facilitate Interoperable Wireless Communications National Requirements and a National Architecture Are Needed

Page 9 GAO-04-1057T

document that will define future communications services as they change or become new requirements for public safety agencies in carrying out their missions. SAFECOM officials said additional versions of the Statement will incorporate whatever is needed to meet future needs but did not provide specific details. A national architecture has not yet been prepared to guide the creation of interoperable communications. An explicit, commonly understood, and agreed-to blueprint, or architecture, is required to effectively and efficiently guide modernization efforts. SAFECOM officials said they are responsible for development of a national communications architecture and that will take time because SAFECOM must first assist state and local governments to establish their communications architectures. They said SAFECOM will then collect the state and local architectures and fit them into a national architecture that links federal communications into the state and local infrastructure. Technology solutions by themselves are not sufficient to fully address communication interoperability problems in a given local government, state, or multi-state region. State and local officials consider a standard database of interoperable communications frequencies to be essential to frequency planning and coordination for interoperability frequencies and for general public safety purposes. Police and fire departments often have different concepts and doctrines on how to operate an incident command post and use interoperable communications. Similarly, first responders, such as police and fire departments, may use different terminology to describe the same thing. Differences in terminology and operating procedures can lead to communications problems even where the participating public safety agencies share common communications equipment and spectrum. State and local officials have drawn specific attention to problems caused by the lack of common terminology in naming the same interoperability frequency.

The Public Safety National Communications Council (NCC) was appointed by the FCC to make recommendations for public safety use of the 700 MHz communications spectrum. The NCC recommended that the FCC mandate Standard Databases and Common Nomenclature Have Not Been Established

Page 10 GAO-04-1057T

(1) Regional Planning Committee7 use of a standard database to coordinate frequencies during license applications and (2) designation of specific names for each interoperability channel on all pubic safety bands. The NCC said that both were essential to achieve interoperability because public safety officials needed to know what interoperability channels were available and what they were called. In January 2001, the FCC rejected both recommendations. It said that the first recommendation was premature because the database had not been fully developed and tested. The FCC directed the NCC to revisit the issue of mandating the database once the database was developed and had begun operation. The FCC rejected the common nomenclature recommendation because it said that it would have to change the rules each time the public safety community wished to revise a channel label. In its final report of Jul. 25, 2003, the NCC renewed both recommendations. It noted that the FCC had received a demonstration of a newly developed and purportedly operational database, the Computer Assisted Pre-Coordination Resource and Database System (CAPRAD), and that its recommendations were consistent with previous FCC actions, such as the FCC's designating medical communications channels for the specific purpose of uniform usage. In 2001, OMB established SAFECOM to unify the federal government's efforts to help coordinate work at the federal, state, local, and tribal levels in order to provide reliable public safety communications and achieve national wireless communications interoperability. However, SAFECOM was established as an OMB E-Gov initiative with a goal of improving interoperable communications within 18-24 months—a timeline too short for addressing the complex, long-term nature of the interoperability problem. 8 In addition, the roles and responsibilities of various federal 7In 1987, the FCC developed a National Plan for Public Safety Radio Services that set national guidelines for use of the 800 MHz spectrum while allowing regional public safety planning committees to develop regional plans tailored to their areas own particular communications needs. A large portion of the 700 MHz public safety spectrum, approximately 53 percent (12.5 MHz), is designated for general use by local, regional, and state users. A regional planning process was adopted to govern management of this public safety spectrum. It is a process similar to that used in the 821-824 MHz and 866-869 MHz bands. Regional Planning Committees (RPCs) are allowed maximum flexibility to meet state and local needs, encourage innovative use of the spectrum, and accommodate new and as yet unanticipated developments in technology equipment. They are responsible for creating and managing regional plans 8U.S. General Accounting Office, Project SAFECOM: Key Cross-Agency Emergency Communications Effort Requires Stronger Collaboration, GAO-04-494 (Washington, D.C.: Apr. 16, 2004). SAFECOM's Functions Are Critical for a Long-Term Program

A fundamental barrier to successfully addressing interoperable communications problems for public safety has been the lack of effective, collaborative, interdisciplinary, and intergovernmental planning. 18DHS officials said that, in addition to outlining the eligibility for grant dollars and the purposes for which federal dollars can be used, the SAFECOM grant guidance provides consensus guidelines for implementing a wireless communications system. DHS said this guidance is useful in directing all agencies towards interoperability goals, even if they are not specifically applying for federal funding. No Coordinated Federal or State Grant Review Exists to Ensure Funds are Used to Improve Regional or Statewide Communications Interoperability

### CONCLUSIONS

Jurisdictional boundaries and unique public safety agency missions have often fostered barriers that hinder cooperation and collaboration. No one first responder agency, jurisdiction, or level of government can “fix” the nation's interoperability problems, which vary across the nation and often cross first responder agency and jurisdictional boundaries. Changes in spectrum available to federal, state and local public safety agencies- primarily a federal responsibility conducted through the FCC and NTIA—changes in technology, and the evolving missions and responsibilities of public safety agencies in an age of terrorism all highlight the ever-changing environment in which interoperable communications needs and solutions must be addressed and effective federal leadership provided. Interdisciplinary, intergovernmental, and multi-jurisdictional partnership and collaboration are essential for effectively addressing interoperability shortcomings. In our July 2004 report, 19 we made recommendations to DHS and OMB to improve the assessment and coordination of interoperable communications efforts. We recommended that the Secretary of DHS: in coordination with the FCC and NTIA, continue to develop a nationwide database of public safety frequency channels and a standard nationwide nomenclature for these channels, with clear target dates for completing both efforts;
establish requirements for interoperable communications and assist states in assessing interoperability in their states against those requirements;
through DHS grant guidance encourage states to establish a single, statewide body to assess interoperability and develop a comprehensive statewide interoperability plan for federal, state, and local communications systems in all frequency bands; and
at the appropriate time, require through DHS grant guidance that federal grant funding for communications equipment be approved only upon certification by the statewide body responsible for interoperable communications that grant applications for equipment purchases conform with statewide interoperability plans. 19U.S. Government Accountability Office, Homeland Security: Federal Leadership and Intergovernmental Cooperation Required to Achieve First Responder Interoperable Communications, GAO-04-740 (Washington, D.C.: July 2004). We also recommended that the Director of OMB, in conjunction with DHS, review the interoperability mission and functions now assigned to SAFECOM and establish those functions as a long-term program with adequate authority and funding. In commenting on our July 2004 report, the Department of Homeland Security discussed actions the department is taking that are generally consistent with the intent of our recommendations but did not directly address specific steps detailed in our recommendations with respect to establishment of statewide bodies responsible for interoperable communications within the state, the development of comprehensive statewide interoperability plans, and tying federal funds for communications equipment directly to those statewide interoperable plans. OMB did not provide written comments on the draft report. This concludes my prepared statement, Mr. Chairman. I would be pleased to answer any questions you or other members of the Subcommittee may have at this time.
   The Spectrum Needs of Our Nation's First Responders
   Prepared Witness Testimony by Dr. Norman Jacknis Subcommittee on Telecommunications and the Internet-Jun. 11, 2003 11:00 a.m. 2322 Rayburn House

Mr. Chairman, Fred Upton, Ranking Member, Edward J. Markey, Westchester's own Representative, Eliot Engel and other distinguished members of the subcommittee, thank you for holding these hearings on the radio spectrum needs of first responders. I am the Chief Information Officer for Westchester County—the commissioner in charge of the County Government's technology and telecommunications. This includes the 911 system, the systems for dispatching fire and EMS units, radios and other forms of wireless communications, emergency management systems, emergency notification systems, the bioterrorism early warning system, and so on. With a population of about 950,000 people, two active nuclear reactors, New York City's water supply, corporate headquarters for several fortune 500 companies among other possible locations of a disastrous incident, Westchester County is as good a place as any to understand the potential impact of the radio spectrum deficit facing public safety and emergency workers. As a suburban county, just north of New York City, we demonstrate the kinds of communications issues that arise in the handling of incidents—both large and small—that do not limit themselves neatly to one side of a municipal border.

Westchester County also offers, in microcosm, the common picture of multiple first response agencies. In addition to the County Government's special services in Hazmat, bomb squad, fire training and the like, Westchester has more than forty other police departments, fifty-eight local fire departments (comprised of career, volunteer firefighters or a combination of the two), forty-two emergency medical service agencies, and more than fifty public safety answering points in our 911 system. Day-to-day, the County Government ensures that the communications network underlying these activities is working and we dispatch a majority of the fire departments in the county.

The County Government plays a critical role in coordinating these agencies, especially in the face of a major emergency. In the absence of true interoperability between all of these agencies, we are the only mechanism for these various units to coordinate their activities.

However, by the standard Federal definition, we are not “first responders” and so we are not eligible for funding to improve the communications for first responders. I would suggest that Federal law needs to be amended to reflect the involvement of agencies that handle communications (like the County) in addition to those that physically respond to an everyday incident.

In the first hours following the attack of Sep. 11, 2001, the only way we could coordinate the sharing of firefighting, Medical Examiner, Health and Information

Technology resources with New York City officials was through the highly trained, volunteer Amateur Radio (ham) operators. This was a result of the fact that normal commercial communications services were unavailable. There was no other single, common communications medium, except the Amateur Radio Service. This irreplaceable resource must be protected against incursion by other interests.

In the past, an answer to the needs of public safety, particularly police, was the use of radios in the 800-Megahertz band. Indeed some of Westchester's police departments use such frequencies in their local areas. However, the County never received an allocation of 800-Megahertz frequencies and is not able to get any because it sits in a large metropolitan area where these frequencies are already licensed to other jurisdictions, such as New York City.

More recently, there have been numerous complaints across the country of interference with these frequencies by commercial wireless services. In turn, there has been extensive lobbying to have local public safety agencies exchange their 800-Megahertz frequencies for others in the 700-Megahertz range. No matter what the outcome of these efforts, it is clear that 800-Megahertz, in our area, has not fulfilled its promise as the single frequency range for first responder coordination and communications.

So the 800-Megahertz strategy of the FCC has been replaced by a plan to allocate spectrum in the 700-Megahertz range for public safety uses. This too is years away in New York State and elsewhere. In New York, a large part of the northern part of the state faces interference from Canadian uses of the same frequencies. In the city metropolitan area, including the suburban counties of the lower Hudson Valley, these frequencies are still used by television stations. It will be 2007 at the earliest that we could get access to these frequencies.

There was some discussion about this bandwidth being able to carry more than the traditional voice communications. However, the FCC's plans for the 700-Megahertz range call for it to be split into voice channels in such a way that it will not support the more advanced forms of communications that are increasingly needed and that emerging technology is making possible.

As it tries to help, it is important for Congress to realize that the traditional solution does not reflect the future of communications and will not meet the more demanding needs of first responders. That traditional solution is to give them a nice big radio that allows them to talk.

Voice communication is essential, but so is the ability to deliver data and video. The first responders need information, like floor plans, on-demand video instructions on how to recognize a contagious disease, details from a geographic information system, transmission of medical data from patients, a view from inside a school building, and the ability to show and discuss what is happening at an incident to an emergency operations center miles away. These are only some examples of the extraordinary expansion of first responder communications capabilities that would be possible, if the spectrum for public safety were managed for the future and not the past.

This is certainly not without precedent. When the suburban counties in metropolitan Washington, DC, realized their failure to properly coordinate in the face of a plane crash into one bridge and then a “jumper” off another bridge, they organized to create a data network (CapWIN)—not just buy the more traditional radios. This has become an enormous success for them, even though they are dependent upon a variety of commercial communications services.

Later today, we are scheduled to show Congressman Engel some examples of modern first responder communications that are possible even in the unlicensed 2.4 Gigahertz range. These are also examples of the efficient use of spectrum because of their reliance on the communications protocols of the Internet. Moreover, these same protocols allow for easy interoperability between agencies with all kinds of different radio, voice, video and other equipment. Commonly called Wi-Fi (a part of the 802.11 family of standards), this is the fastest growing, most competitive, least expensive and most innovative sector of the communications market.

These are impressive technologies, but the problem is they are dependent upon unlicensed frequencies that are getting more crowded and commercialized. Public safety, emergency managers and first responders must have reliable delivery of the information required for proper decision-making and the protection of people's lives. They need sufficient and reliable spectrum to use these modern technologies—but without worry about being crowded out.

In recognition of this need, a few weeks ago, the FCC took a first step by deciding to allocate to public safety about 50 Megahertz of spectrum in the 4.9 Gigahertz range. This is less than the 100 or 200 Megahertz originally anticipated for these needs. It excludes communications to police surveillance helicopters. There is also potential interference from powerful Navy radio equipment, especially in the more populated coastal areas of the country. Nevertheless, this is a good first step forward.

Congress can help to ensure that this decision will achieve its potential to become the basis for the first responder communications system that people deserve. There are four necessary Congressional actions:

First, urge the FCC to make this spectrum available soon. We cannot wait for a years-long regulatory process.

Second, make sure that commercial or other interests will not encroach or interfere with this allocation of spectrum, as has been the case with the previous 800-Megahertz and 700-Megahertz plans. This also means that the new spectrum allocation would be exclusively for public safety and emergency response use of governments or their agents. In the case of my county, that definition includes our public transportation system, which plays an essential role in evacuating the public from harm, especially schoolchildren.

Third, encourage the FCC to adopt a more modern approach to allocating these frequencies, in accordance with the more modern digital technologies they say they want to support. Rather than slicing up the spectrum into less usable allocations to individual agencies, it would make sense to dedicate the whole swath of this spectrum to encourage the deployment of a wireless, secure, Internet-like data network modeled on the way that 2.4 Gigahertz works. Bearing in mind the public safety purpose of 4.9 Gigahertz, the FCC would then permit only authorized agencies to send data over an infrastructure built out by regional (or even Federal) organizations. Fourth, while modern communications technology is much cheaper to deploy than traditional radio systems, it is not free. Like other local and state governments around the country, Westchester has mostly footed the bill for homeland security on its own, but cannot afford to build out the communications infrastructure or continue to spend to keep up with the improvements in technology. The absence of financial resources can stop progress cold. For this reason, it is good to see that Congressmen Engel, Fossella and Stupak are working with Chairman Upton to create a trust fund for this purpose. Considering that Federal emergency management agencies will also be able to use the new spectrum allocation, the funding will help both the Federal and local governments to protect the public in these ever more dangerous times. Again, I thank you for your interest in this critical problem and I welcome any questions.

All of the above including the testimony given in hearings to the various governing agencies FCC, DHS, congressional committees, etc and appearing in this OMB document have been chosen because they relate the necessary information and data that is currently needed for interoperability of communications at the First Responder Level. This Technology the PFN/TRAC System and FACT Security program under development since 19994 has wrestled with the disparate communication and machine messaging problem from the start. The technology represent a thinking out of the box local multi- wireless accountable interface with translation processing that is just ideal for the situation the United States finds itself resting with as stated clearly above. The technology was historically designed as a result of the wreck lace self serving sale and distribution of wireless communication licensing by the Federal Communication Commission over the past years. Other countries have been far more responsible in their scientific appreciation of frequency and bandwidth for the accommodation of data messaging/video and voice communications and grouping together of applications on dedicated frequencies and protocol standards. With this said the PFN and PS1 platforms are the immediate answer to this free enterprise communication disparity and the ongoing answer to complete the above prescribed path to achieve inter operability.

Router Relay Translation Applications immediate design characteristics must provide the following in FIG. 3 local ASIC Configuration. It is being taught this way because the earlier aviation application and land transportation models have more clarity as to the wireless chosen for application. The disparity in the first Responder requires coordination with the efforts underway and are therefore discussed in this manner.
Support IF input channels and IF output channels per board
Support input signal bandwidths to include those use today
Supports IF generation
Bus architecture specifically designed to support ultra-high data rates to/from the FPGA processing engine
Support time stamping of ADC data
Support signaling required for frequency hopping applications
Designed to meet high availability system requirements
   Applications
Military Communications (e.g. JTRS, ACN), Wideband Analysis, Direction Finding, Signals Intelligence, Waveform Development, Commercial wireless (e.g. Satellite gateways, cellular base station fast as possible, Fire, Police, EMS P-25 Wireless protocols HSD,FEMA, etc
   Features
Compact PCI I/O transition module form factor, Plug Play and program,
ADC channels 80 MHz, 14-bit ADC SFDR=78 dB
DAC channels @ 160 MHz, 14-bit
Support optimum full-duplex interface via cPCI J5 connector (TM1 interface), and any appropriate hardware connectables
External frequency reference input for accurate sampling frequency control and time stamping
Sampling frequency can be varied with external clock
time code input for time stamping
Synchronization connector for the optimum DDCs/DUCs running on processing boards to be synchronized for beam forming
External application-specific system clock input
Support control of RF front-end units (hybrid chipsets at first via general purpose I/O, including four 12-bit ADCs and four 12-bit DACs
User-programmable LEDs for development and debugging and or LCD display and diagnostic menu
Supported by appropriate COTS software library, Developer translation algorithms for the various wireless protocols e.g. Spectrum's quicComm
   Mobile Applications
   Radio Interoperability in a Multi-Jurisdiction Crisis through Networked Devices and Establishing a Gateway to Legacy Devices

Real-time video feeds to all networked devices including in-vehicle displays, command centers and handheld tactical units wireless PDAs Multi tasking wireless phone systems Nextel technology etc. 1P PFNs that are infringed on by the prior products made but not licensed.

Situational Awareness for all Responders on the Scene

Automated Data Collection from Sensors Networked to the System Including Perimeter Security, Hazardous Material Detection, and Video Surveillance

Robot Communications for Search & Rescue or Bomb Clearing

### CONCLUSION

Mobile PFN networking enables broadband wireless communications in the absence of existing infrastructure ideal for first response situations, and will deliver essential information and data to local Radio disparate First responder units in a prescribed manner for proficient interaction and task completion. It ensures the interoperability, scalability and reliable performance required in large-scale emergencies where tactical communications are better served by networking on the fly enabled by a PFN network solution. PFN technology links more than just voice communications. It also supports live video and high-activity data communications to incorporate valuable, real-time and possibly life-saving intelligence into the emergency response strategy that is delivered comprehensively or in a discriminate or individual manner. The PFN smart cell network provides interoperability and communications that could be managed and the radios range are extended via of a multi interfacing and a self-managing network where each radio in the system can be a repeating station for a flexible web or network as determined by the PFN or PS1 processor's capability to receive from other units in the network-The responding units make the network. PFN backward engineering for legacy 800-MHz radios, bridge the networks to traditional networks in the system.

A network normally relies on Internet Protocol (IP), a universal networking standard, to intertwine wirelessly between IP-enabled first responder devices and networks. Unlike existing point-to-point radio systems, there is no central point of failure with a PFN based repeating system. These above communications are still processed in the PFN, but the system is comprised of smart pockets that through a commend string algorithm can determine the optimal communication path to develop a smart cell. The more radios that join the PFN cell and PFN/TRAC/FACT routing, relay translation system the more diverse and failure-resistant local communications are and state and federal links. This figure teaches of this PFN application as a translator Communication Router function of the PFN. The Primary Focal Node is designed as an interface for local and long distant disparate communication protocols. It serves as the interface component for first responder transceivers in this illustration by being able to be programmed by satellite with newly arriving military, government and first responder communication data. These universal PFNs have universal antenna arrays. They also have a scanning function to identify new frequency transmissions, Identify them and request the communication link data from the governing agencies and manufacturer servers or link the P-25, or report unidentifiable transmission to DOD, FCC, FBI. And any other agency relevant to such activity for Public safety and national security.

The way this function works when coordinated from the National or Regional Homeland Security HS; the control center sends a signal to and from a satellite link that a new asset (fire Department) is being deployed to a troubled area (disaster area, etc.) the responding translator/router PFNs in the disaster area receive the download to include any digital protocols and frequency data of the arriving new units and sets up a software file crossover or lookup process and begins in scan mode searching for the new arrival units. The new arrival units handshake with their unique ESN identification signal or digital signature and the process begins by the PFN identifying as many individual unique units and singular communication channels both analog and digital with respect to the protocol downloaded. The down load frequency information, protocols and individual ID data are recorded and updated from time to time and stored in the specific coordinating agency or agencies e.g FEMA, HS, TSA, NSA or all of the above servers.

All government agencies are to have application level encryption and to triger their access and maintain their sovereignty. And, the local recordings and server recording are for accountability and accounting for the agency to prove their work value for their budgets the GAO and congress. An expansion of this function globally is to be used for accountability and world loan and aid enforcement and use of funds as well as record in real-time the result and effects of policy and projects. Most importantly is the capacity of midcourse correction to policy or practices that are in place through the PFNs, is that they can be reprogrammed in the same manner instantly for a policy or practice that is unconstitutional or illegal.

The downloads are encoded from specific managing agencies and the transactions and communications are record locally and in the agency servers with a time, date and geographic stamp. All PFN translation routers have a GPS receiver integrated or landline connected and programmed to report their fixed addresses. In earlier filings for the PFN/TRAC movement management system the agencies are set up with registries for equipment and material identification technologies to track their movement use and control their unlawful and unsafe use. The development of this architecture will aid this first responder really application by providing remote control and robotics to virtually all equipment in a first response area as well as, provide distant remote control of same equipment via a PFN relay station that is configured as an equipment controller as well.

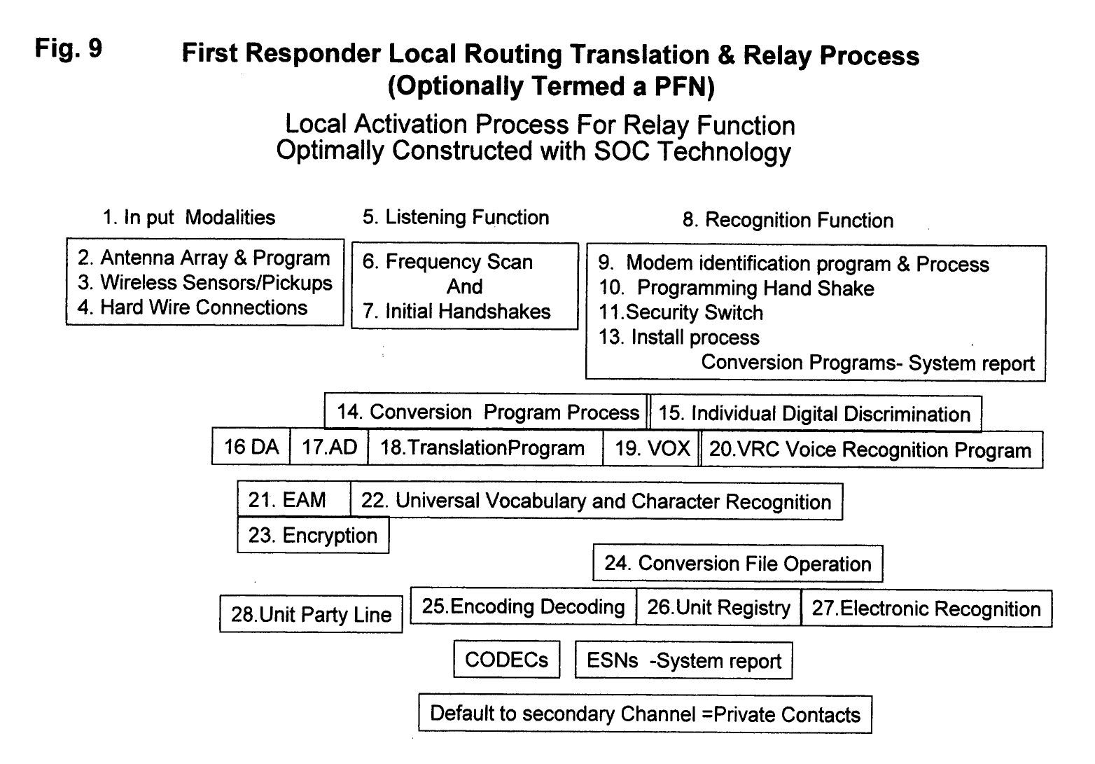

FIG. 9

This figure is to detail out more of the translation relay process for PFN ASIC routing for those skilled n the art to configure final design as per industry and governmental directional choices. As is the process for the PFN/TRAC Technology in all applications to be a Primary Focal Node for all relevant messaging and communications the incorporation of existing and legacy technologies is the first organization step to meet these needs. This has been done to some extent in FIG. 8 with the OMB document, but the identifying of COTS product and manufacturers for this Universal translation router relay station interface is discussed through a flow chart and the interface of the relevant technologies.

In the first block to the left Clocked pulsed transmissions to synchronize input/conversion and output data pulses- as well as smart web handshake handoffs of local ESNs detected like a cell system is utilize to manage the process. The signals have to be received first even for the system time to sync the local clock. The input modalities include Antenna, sensors and pickups and or hard wire connections 2a. One product to handle much of the wireless receiving communications is the New TECOM Phased Array Antenna Covers Wide Bandwidth TECOM Industries, a manufacturer of antennas and antenna systems, has completed the development of a new modular phased array antenna as a result of winning a competitively bid program. The application is a US Government program.

There are others and this is named as possible COTS technology that can be interfaced to more rapidly provide a diverse array of universal translation relay stations. The antenna has wide bandwidth and gain, and is able to scan +/−60° in the azimuth plane while remaining in a fixed pattern in the elevation plane. Antenna size is 24 by 24 by 6 inches. The antenna has a gain of 12 to 20 dBiL. The modular architecture of this new antenna allows the aperture to be scaled for different applications based on the specific number of panels required. The antenna operates over a 2.5:1 frequency bandwidth. The new TECOM Phased Array Antenna is an innovative, highly integrated and cost effective, solution that addresses current and future needs for phased array antennas in the military, security and wireless communications infrastructure applications. The antenna system is designed for both ground and airborne usage. The innovations are the wide frequency bandwidth, wide scan angle and dual polarization. ttp://www.tecom-ind.com/

2b. MTI Wireless Edge Announces a New 900 MHz 10.5 dBi Horizontal Polarity Low Cost Compact Omni Antenna

MTI Wireless Edge Ltd., a developer of high-quality, low-cost flat panel antennas for Fixed Wireless applications, has released a new compact Omni antenna, covering for the 900 MHz ISM unlicensed frequency band for PtMP (point-to-multipoint) applications. The Omni antenna is Horizontal polarized with 10.5 dBi gain and very small size. The antenna height is 1.5 m and it weighs 8.5 Kg. The antenna is built to withstand the toughest electrical and environmental requirements according international standards such as ETSI. This antenna joins the MTI's large product line of 900 MHz antennas, including 8/9/10/12.5 dBi directional antennas, 90/120° V-Pol and H-Pol BTS antennas, and 8/12 dBi V-Pol and H-Pol Omni antennas. With the completion of their production process program, MTI is now mass-producing this antenna giving them the ability to offer very short delivery times. For more information visit http://www.mtiwe.com/

2C. Antenna control software picoChip Integrates ArrayComm's Network MIMO Software for WIMAX picoChip and ArrayComm have forged an alliance, under which ArrayComm's Network MIMO software will be incorporated into the PHY of picoChip's flexible wireless solution. picoChip will offer this solution as a software option to its customers to add smart antennas and MIMO to their advanced WiMAX basestation and subscriber station designs. ArrayComm's Network MIMO software implements all the antenna processing aspects of the WiMAX profiles approved by the WiMAX Forum Mobile Task Group (MTG) for IEEE 802.16e. The ArrayComm solution includes support for MIMO, adaptive antenna systems (MS) and combined MIMO/AAS modes on both subscriber terminals and base stations. These provide operators the optimized user data rates, cell range, and network capacity they need to meet their business objectives for mobile broadband services. MIMO and AAS, used in combination, increase subscriber data rates, improve cell-edge link budgets, manage interference, and maximize overall network capacity. The result is a significant performance advantage for WiMAX. ArrayComm provides Network MIMO software that integrates with picoChip's WiMAX PHY and picoArray processor. Commenting on the new agreement, picoChip's CTO and Co-founder Doug Pulley said, “Adaptive antenna technology and MIMO are key distinguishing features of the WiMAX specification; they will be critical in assuring WiMAX success. This functionality, as an option for the picoChip software, will be a major advantage to picoChip's customers, giving them the flexibility to easily incorporate smart antenna technology into their designs. picoChip believes that ArrayComm is the leader in this space and we want our customers to have the best. “OpicoChip has demonstrated that it is ahead of the game in providing innovative and flexible solutions for wireless broadband access systems. Future applications will need smart antenna technology to deliver the cost and performance advantages that WiMAX promises. This partnership is a significant step toward realizing our shared vision for the future of WiMAX technology,” added Martin Cooper, ArrayComm's executive chairman. For more information visit http://www.arraycomm.com/

These 3 companies above are presented to teach the direction of a progressive design to not only engineer for existing individual radio use by the first responders but also to take advantage of existing combining technologies that can be quickly incorporated to configure and construct this latest PFN interface application. As stated through out this application other wireless communications not requiring an antenna like light transmissions, sound etc or direct connectables hard wire connections are well described and documented in prior applications like 10/975,109 and incorporated herein by reference.

6. RF Frequency scanning : is well covered in the prior related filings to include 10/975,109. As mentioned earlier the recognition identification and reporting of detected signal is part of the translation routing relay process in patent Aviation the scan function in PFNs is to detect possible terrorist activity in and around the airport. While the initial scan functions are to identify authorized radios for an emergency event and coordinate communication between protocols another portion of this function is to meet the optimum ocilation and conduction for signal propagation though a host of ranges and conditions. For this reason the PFN designers for the First Responder environment might do well to review the following concerns n choosing final design and materials

First Responder Communications—First responders need reliable communications in emergency scenarios. Disaster scenarios and terrorist attacks may result in scenarios where responders or citizens are trapped in collapsed or blocked buildings. The propagation of signals in the bands used by first-responder radios and cellular telephones needs to be investigated. We have performed unique experiments to define communications links in buildings prior, during, and after demolition. These data will give invaluable insight into the communications challenges faced by first responders. We are additionally investigating alternative methods to detect and locate trapped persons.

Complex Boundaries—Meta-materials (i.e., engineered or man-made materials) have received considerable interest in recent years. Metamaterials are commonly engineered by arranging a set of scatterers throughout a region of space in a specific pattern so as to achieve some desirable bulk behavior. Examples of electromagnetic metamaterials are artificial dielectrics, photonic bandgap structures, and frequency- selective surfaces. Recently there have been studies on the properties and potential applications of doublenegative (DNG) materials. We are investigating a composite medium consisting of insulating magneto-dielectric spherical particles embedded in a background matrix to achieve DNG behavior. We have shown that the effective permeability and permittivity of the mixture can be simultaneously negative for wavelengths where the spherical inclusions are resonant.

Standards Committees—We work closely with national and international standards bodies to transfer experimental and theoretical results and to improve test methods for large, complex systems. We plan to continue participation in various IEC, CISPR, ANSI, SAE and IEEE standards committees related to EMC test methods.

Accomplishments

Probe Response Model—An improved response model for a diode-based electric field probe was developed. The model is being used to improve probe calibrations, particularly in a reverberation chamber where dynamic range is large.

Phantom Study—The electric field statistics in a heavily loaded reverberation chamber were evaluated and compared to the empty-chamber statistics The load consisted of phantoms (water bottles) filled with tissue-simulating liquid. Wholebody average specific absorption rate (SAR) in the phantoms was also determined via direct (temperature-increase) and indirect (insertion-loss) measurements. The results support the use of a reverberation chamber for animal exposure studies.

Propagation in Collapsed Buildings—Two experimental studies on signal propagation in buildings prior, during, and after demolition were completed. These experiments provide invaluable data on first-responder communication challenges.

Effective Boundary Conditions—Effective boundary conditions for thin films with applications to active materials such as frequency-tunable surfaces have been derived and published

7. Handshakes for the various of RF systems and entire communication code as well as translation programs exist from the various manufacturers. The hardware and software conversion programs will prove far lees challenging than getting the commercial cooperation from many companies. Hopefully this will improve in the future with the expanding business and services provided through universal interfacing

8.9.10.11.13. are functions that could be processed and performed in a number of ways and they are well covered through this application and the prior technology. The order in which they are performed will depend on procedure and protocol decisions and how the specific code is written.

14 Conversion

Any Converter will be designed for applications requiring a high performance RF front-end for DSP or computer based signal analyzers. The 8085 can be connected directly to broadband antenna systems, and will provide all necessary RF translation, filtering and gain controls to build a high dynamic range DSP-based digital radio. A Converter should consist of at least one or have multiple Down converter modules, and at least one Synthesizer module. If possible the PFN unit should tune to any RF signal between the usable range finally determined, and convert the tuned RF frequency to a compatible frequency for 16-17 high-speed, 12 to 16 bit A/D converters used in high performance signal processing systems. A standard VME plug-in module should exist in the RF I/O front end of the ASIC in FIG. 3, and are controlled via the VME bus. In this modality the modules should meet all VME physical and electrical interface standards. If another multipin connection or standard is decided on or standardized than these components would be constructed for plug and play capacity of this different protocol. For multiple channel configurations (3 to 16 channels), Poly-connectors distribute the common synthesized oscillators from each single synthesizer to a multitude of down converters.

15. Description

The PFN Processor is designed to work with COTS software like Spectrum's SDR-3000 series software defined radio subsystems. It contains an appropriate number of ADCs and DACs, running at sampling rates suitable for most standard frequencies, and should be specifically designed to achieve exceptional signal to noise performance in relation to the wireless application. It must interface to any RF translation unit with an analog IF or baseband interface, while digitized data is transferred to/from the PFN processor via a high- speed digital bus.

16 & 17 ADC Converters DAC Converters

The units Analog Devices 14-bit, 160 MSPS DACs. The sample rate into the DAC is 80 MSPS, which can be sampled by a 2× interpolation filter to 160 MSPS. This allows direct generation of 70 MHz IF signals by moving aliased frequency components up to frequencies near 160 MHz. The DACs provide an ideal mechanism to calibrate multiple antennas in beam forming or direction finding applications.

Synchronization

In order to facilitate a wide range of synchronization features:

[ADC and DAC Sampling]

The ADCs and DACs are synchronized to a single clock source so that all sampling is coherent. This synchronization can either be to an on-board or external oscillator.

[ADC Time Stamping]

An IRIG-B GPS-based time stamping feature is included, allowing time-of-year time stamps to be embedded in the ADC data, with a precision of one 80 MHz sample clock is compatible with IRIG-B002 positive pulse, 50 ohms, base band inputs.

18.

[System Clock Input]

A special system clock input connector connects the signal between to the FPGAs. Any user-defined feature can be implemented using this facility, however the intent is to allow an external device to trigger NCO frequency changes in DDCs/DUCs running in the FPGAs. This is useful in frequency jumping applications.

[Software Initiated Control Events]

A special feature allows the embedded controller to initiate synchronization signals. A typical use of this feature is to synchronize NCOs in multiple digital down converters.

[Multiboard Synchronization]

Many can be synchronized to each other via the time sync connector. In this configuration, the first board becomes the master and generates synchronization signals to the others, which are slaves. The following signals are then synchronized across all boards:
Frequency reference (for ADC and DAC sampling)• IRIG-B time stamp
System clock• Software initiated events
   General-Purpose I/O

A series of general-purpose I/O signals are supported to provide control of the pass band center frequencies, gains, and other functions of the RF front-end transceivers unit. These signals can be summarized as follows:
One UART interface (RS232). The UART itself is embedded controller
Four analog inputs. These are fed to four 12-bit ADCs
Four analog outputs. These are driven by four 12-bit DACs
8 digital I/O pins
One interrupt pin-can generate an interrupt on the embedded controller
   Software
   COTS

A comprehensive quicComm library can provide a simple interface to all board-level control functions. This library actually executes on the embedded controller.

1. A claim is made for two wireless repeater/control processors which interface a multiple of electronic messaging and provide translation between protocols and route signal and messaging to both distant networks and locally, to mini smart cells made up of these two processors and or any other wireless technologies; with these two proprietary processors optionally termed Primary Focal Node (PFN) and (PS-1 ) a smaller dedicated self powered version of the PFN; and with the PS-1 micro processor generating at least one specific signal from one of a sensor, scanner reader, video cam, audio pickup, GPS system, other locating technology and or other connected device, object, Satellite link, or wireless, memory storage etc, and delivering same signal to its larger version or PFN for any additional processing conditioning, translation, storage or longer range communication conditioning and retransmission along with the PFNs similar capacity with; at least one specific signal from one of a sensor, scanner reader, video cam, audio pickup, GPS system, other locating technology and or other connected device, object, Satellite link, or wireless, and memory storage, power source and emergency backup, physical and electronic protection.

2. A claim according to claim 1 is made for this technology as part of and optionally termed the Primary Focal Node/Trusted Remote Activity Control or PFN/TRAC System, as an inclusive accountable movement management and or communication system designed to enhance public safety, the quality of life, and national security through hardware and software implementation optionally call Federal Access Control Technology or FACT Security program with multiple applications to include; a universal electronic payment, instrument for local and systemic credit card processing and accounting, to include short range communications, electronic RFID identification and network authentication technologies; Easy Pass, Mobile pass and Master Card short range device ID account debit system, magnetic strip readers, barcode readers, scanners, finger print ID, Iris Id and account programming, Face ID and accounting program, any arbitrary biometric ID sensing, DNA, voice recognition and accompanying accounting software or programming, cell phone ID and accounting program ID ESN and accounting program, secondary short range wireless links, Bluetooth, 802.11 or Ethernet, etc and accompanying accounting program.

3. A claim according to claim 1 is made for this technology as part of and optionally termed the Primary Focal Node/Trusted Remote Activity Control or PFN/TRAC System, as an inclusive accountable movement management and or communication system designed to enhance public safety, the quality of life, and national security through hardware and software implementation optionally call Federal Access Control Technology or FACT Security program with multiple applications to include, any accounting process for the recognition and accounting of frequency and substance transmissions, to include general commercial broadcasting of program or advertisement or service message that is either electronically labeled and or identified or accompanied or imbedded or encoded with an analog or digital signal or identifier to be recognized by software programming running in the processors of a broadcast cell of PFNS for the purpose to perform automated watchdog functions, research, analyze, enforce or prove such broadcasting occurred for either security or commercial applications, private interests or government regulations.

4. A claim according to claim 1 is made for this technology as part of and optionally termed the Primary Focal Node/Trusted Remote Activity Control or PFN/TRAC System, as an inclusive accountable movement management and or communication system designed to enhance public safety, the quality of life, and national security through hardware and software implementation optionally call Federal Access Control Technology or FACT Security program with multiple applications to include a universal translation capacity for First Responder Radios to include a PS1 piggy back translation package for first responder radio assets; to include local fire and or emergency services, local law enforcement, locally dispatched state and federal law enforcement and or state and or federal emergency/disaster radio assets, to include Homeland Security Department and or FEMA workers wireless communication devices, any appropriate federal military, and state militia or national guard wireless units, through the responsive interfacing of these radio and wireless phone systems by either a dual or universal antenna technology to include chip hardware, software or firmware, integrated circuit(s) or Systems On a Chip technology that optionally include a analog to digital conversion and or digital to analog conversion and or cross translation of digital protocols and or utilizes any short range communication link or a hard wire connectable to complete the optimum interoperable interface for disparate communications

5. A claim is made for a universal electronic translation router relay station with optional GPS, or as part of a general or application specific equipment controller, processors and or micro processors optionally termed PFN and PS-1 that interface responsively and or are connected to antenna, dish, sensors, audio, video inputs, receptors, receivers, transceivers, and run the appropriate programming.

6. A claim according to claim 1 is made for an optionally responsive equipment controller connected to equipment electrically to function as a master interface and controller over the equipments Electrical/Electronics system(s) and provide remote control and robotics and to interface any electronic payment recognition device for the wireless payment industry and for national security data mining
